(19) United States
(12) Patent Application Publication
(10) Pub. No.: US 2014/0325910 A1
(43) Pub. Date: Nov. 6, 2014

(54) Traveling Seed Amplifier, TSA, Continuous Flow Farming of Material Products, MP

(71) Applicant: Sadeg M. Faris, Pleasantville, NY (US)

(72) Inventor: Sadeg M. Faris, Pleasantville, NY (US)

(21) Appl. No.: 13/887,337

(22) Filed: May 5, 2013

(51) Int. Cl. A01G 31/06

(52) U.S. Cl. CPC A01G 31/06
USPC 47/62 R

(57) ABSTRACT

A novel continuous flow farming method for the production of material products is introduced. It is based on 3D SansSoil, (soil-less) mobile multi-layer architecture comprising the traveling seed amplifier, TSA concept, which features the continuous planting of seed mass mᵢ in planting layers, and synchronously harvesting an amplified mass M=Gₛₜₕmᵢ, where Gₛₜₕ is the seed to harvest TSA gain and compresses the intrinsic seed to harvest time, τₛₜₕ, by a factor of N/τₛₜₕ, where N is the number of traveling layers. The TSA continuous flow farming increases the volumetric productivity and 3D yield. In 3D tower architecture, and for plants with short heights annual yield per hectare increases in the range of several 100 to several 1000 are feasible. This architecture saves land, water, nitrate and phosphate resources, alleviating the “food vs. biofuel” concerns, and paving the pathway for food and energy sovereignty.

### RELATED APPLICATIONS

Not applicable.

### BACKGROUND OF THE INVENTION

1. Field of the Invention

This invention is related to the field of agriculture, horticulture, agronomy and agro-economics of food, energy, photosynthetic energy conversion efficiency as well as the utilization efficiencies of other resources, including, time, space, water, and nutrients. Even more specifically, the invention is related to indoor, environmental controlled farming in three dimensional, 3D, spaces, vertical farming, without the reliance on the sun energy or soil. It is also related to 3D farming systems comprising a plurality of layers each of which is capable of sustaining the growth of plants. More specifically, the plurality of layers is permeable in the sense they can pass through water, nutrients, light, shoot and roots of neighboring layers. Even more specifically, 3D soil-less farming for enhancing volumetric productivity and 3D yield by means of continuous flow agriculture capable of synchronous daily planting and harvesting of material products, MP, including plant-made-products, PMP, and culture made products, CMP, used for food, biofuel, medicine, and high performance industrial materials. The species used for the culture and production of CMP include individual living cells, microorganisms, employing cell methods of production. The species may be naturally bred, wild, or genetically transformed by means of transient, plastid, or nuclear recombinant engineering methods.

2. Description of Related Art

My Co-Pending Patent Applications, My CPPA, entitled:

1. SansSoil (Soil-less) Indoor Farming for Food and Energy Production. (CPPA-1)

2. High Density Three Dimensional Multi-Layer Farming. (CPPA-2)

3. Permeable Three Dimensional Multi-Layer Farming. (CPPA-3)

Hereafter, referred to as My CPPA are incorporated herein by reference in their entirety. They presented more detailed background information expounding the limitations and liabilities of conventional soil-based agriculture. They taught inventive teachings of alternative soil-less indoor three dimensional multi-layers farming that are based of the Agriculture Profitability Assurance Law, AgriPAL, and the novel Plant Growth Model, PGM.

Together, AgriPAL and PGM present for the first time, mathematical analytical foundation, based on scientific principles that describe how photosynthesis works, and presents formulas for predicting yield, energy efficiency, and agronomic profitability. They unraveled mysteries that to date eluded and baffled plant scientists and agronomists. They revealed the notion of solar gain, and astonishingly high physiological gains which can be garnered by means of better understanding of resource utilization efficiencies. These gains increase the yields and efficiencies by more than 10 fold and a path to approach and exceed 100 fold.

My CPPA have inspired more transformational inventive contributions that are described in the present application. The background, the formulas and the scientific teachings in CCPA are therefore relied upon heavily in the present application.

Will we Produce Enough Food to Adequately Feed the World?

Advances in health sciences and technologies, in combination with better nutrition, are paving the path to nearly eradicate infant mortality while increasing life spans to beyond the present average of 80 years. Consequently, it is expected that the world population will swell to at least 9 billion by 2050. It has been recognized that such a level of projected population increase will pose a formidable challenges to our planet, stressing its already limited resources: food, energy, land, and water, and fomenting acrimonious competition and conflicts, to obtain and sustain good quality of life and lifestyle.

These challenges have recently been highlighted by the United Nations' Food and Agriculture Organization, FAO, which published the findings of a High Level Experts Forum, in Rome, Oct. 12-13, 2009, entitled “How to Feed the World 2050”. Also in the Jun. 15, 2011 Issue, CO2-Science, published by the Center for the Study of Carbon Dioxide and Global Change, Dr. C. D. Idso, highlighted the challenges in his article entitled “Estimates of Global Food Production in the Year 2050: Will We Produce Enough to Adequately Feed the World?”

Both the FAO and Idso reports reveal an alarming consensus: that a significant per capita reduction is looming, in global food production, arable land, water resources, and farm yields of staple food crops. To avoid the disastrous consequences, they point to the need for a radical paradigm shift in food production technologies, systems and methods. The present food supply-demand gap continues to have devastating consequences in many parts of the world, in the forms of hunger, mal-nutrition, and deaths. According to FAO, there are 1 billion hungry people in 2012. The projected widening of that gap will worsen by 2050 for a 9 billion population. In addition to famine in many parts of the world, geopolitical strife will also cause incalculable adverse effects on the welfare of humanity.

These challenges are further magnified by the following three conflicts:

Conflict #1: Food vs. Less CO2

There are many who are concerned over global warming caused by carbon dioxide emissions. They have embraced the cause of curbing fossil fuel use and are advocating CO2 reduction measures, and urging governments. They have influenced certain governments to act, and laws have been enacted attempting to discourage the use of resources that increase global CO2. However, this position is in direct conflict with the need to sustain life and to feed the world, as a first priority. At present, 1 billion hungry people need urgent attention, growing to be 3-4 billion in 2050. It is puzzling contradiction that the “global warming” community relies of questionable photosynthesis models to predict dire consequences for humanity in 2100, yet they cannot use the same models to understand why plant food efficiency is <0.5% (Table 1). The full and accurate understanding may very well prove that more CO2 is better at absorbing heat and at the same time deals with today's urgent need for food and biofuel. After all, CO2 is the main ingredient for food and life itself (living mass is hydrocarbon matter).

Conflict #2: Food vs. Fuel

Direct consequences of the global warming mitigation are the mandates imposed by the US and EU and other countries to produce CO2 neutral transportation fuel from biomass, biofuel. This presents yet a second conflict with the priority of feeding the world. It is feared by many that biofuel exacerbates the problem by diverting already scarce resources normally dedicated to food production: arable land, water, seeds, fertilizers, herbicides, farming tools. The food and energy price pressures that ensue will make it even harder for many vulnerable segment of the global population to close the nutrition gap. It is feared that their numbers will increase. It is also in conflict with achieving both food and energy security. This food vs. fuel debate continues unabated: http://en.wikipedia.org/wiki/Food_vs._fuel

Conflict #3: Food vs. Forest Land

As shown in Table 1, (http://arpae.energy.gov/Portals/0/Documents/ConferencesAndEvents/PastWorkshops/A BTF %20Workshop %20-%20Ort %20Presentation.pdf) plant scientists, and agronomists agree that the measured efficiency is ˜0.5%, however, they cannot fully account for all the ˜99.5% losses, i.e., the where these losses originate. The full accounting for these losses is the key to inventing ways to minimize them.

Plants store solar energy in the form molecular bond energies of carbohydrates, sugars, starches, cellulose and proteins. The economics of conventional farming, to profitably produce generally affordable staple foods (sugars, cereal grains, legumes, leafy vegetable, and tubers such as: potato, yams, cassava), relies directly on the zero cost of solar energy, ZCOE. This forces cultivation outdoors, on two dimensional lands, because the solar radiation is delivered in units of Watt per unit area (hectares, acres, or square meters).

The reliance on this ZCOE has therefore, forced conventional agronomy to succumb to accepting ˜0.1 to 0.5% efficiencies (see Table 1). One of the main factors leading to such low efficiency is the need to use the soil to support plant growth, and soil borne nutrients which are not easily controlled. This lack of control makes soil a liability rather than an asset. The main concern breeder's have, when producing a new variety, is the specific environment (geography) and the soil mineral composition. This means instead of having one optimum seed that fits all, they will need to produce an astonishingly large number of cultivars of a particular specie in serve as wide market as possible. Even then, production cost constraints will require compromise. This is a consequence of uncontrolled outdoor soil based agriculture.

Therefore, because of the reliance on ZCOE, the growers, and the food production enterprises, have limited or no control. This in turn has lead to the requirement of enormous resources that are inefficiently used, including: insatiable demand for two dimensional arable land, water, fertilizers, and pesticides. To accommodate the population increase from 1 billion in 1800 to the present, ˜7 billion, required deforestation at a high rate. On a global scale, once again, fearing that deforestation adversely impacts the issue of global warming, governments are enacting laws and mandates to restrict increasing farm land by means deforestation. This is the third conflict with the priority to feed the world, and achieving energy security.

TABLE 1
Efficiencies of selected crops
Annual solar energy conversion efficiencies
of C3 and C4 agricultural crops.

| | | | Yield | Efficiency |
|---|---|---|---|---|
| | Crop | Type | t ha⁻¹y⁻¹ | (%) |
| Elephant grass | Pennistum purpureum | C4 | 88 | 0.8 |
| Sugar cane | saccharum officinarum | C4 | 66 | 0.6 |
| corn | zea mays | C4 | 27 | 0.4 |
| beet | beta vulgaris | C3 | 32 | 0.5 |
| rye | lolium perenne | C3 | 23 | 1.7 |
| potato | solanum tuberosum | C3 | 11 | 0.3 |

Farming Profitability and Economic Viability, AgriPAL

In my co-pending FSA, the formulation of Agriculture Profitability Assurance Law, AgriPAL, was presented and discussed extensively. It is repeated here as EQ. (2)

$${η}_{E} ( \frac{{ɛ}_{sol}}{{ɛ}_{other}} ) \frac{\overline{ROE}}{\overline{COE}} \geq ( 1 + p + f + v ) \qquad ( 2 )$$

AgriPAL enables an enterprise to predict profitability of plant growing systems, to prices, and to identify efficiency bottlenecks.

The economic viability index, EVI, is defined as:

$$EVI ≡ {η}_{E} ( \frac{{ɛ}_{sol}}{{ɛ}_{other}} ) = {η}_{E} {g}_{solar} .$$

This links for the first time the economic parameters of farming, profit, p, fixed cost, f, variable cost, v, to the physiological parameters of organisms (plants, algae, other phototrophs), energy conversion efficiency, η_{E}, including a gain factor,

$${g}_{solar} = ( \frac{{ɛ}_{sol}}{{ɛ}_{other}} ) ,$$

wherein, εₛₒₗ, is the solar energy consumed per cycle and, εₒₜₕₑᵣ all other energies consumed.

An enhanced EVI, was derived from a the new Plant Growth Model, PGM, also described in my CPPA, is given by: EVI^{e}≡η_{E}^{e}≡gₑη_{E}. This increases the efficiency by yet another gain factor, gₑ, which can be 10-100, achieved by means of controlling and optimizing physiological growth parameters as well maximizing the temporal and spatial resource utilization efficiencies.

The present invention comprises aspects of AgriPAL that deals with maximizing space utilization efficiencies, which include three dimensional, 3D, soil-less, SansSoil, plant growing structures and subsystems to sustain growth. More specifically, the aspects that reduce the cost of said structures and subsystems which lead to the minimization of the parameter f in Eq. (2). More specifically, the increase of gₑη_{E} which is a function of the N, the number of vertical layers in 3D farming systems wherein the yield is measured in units of ton/hectare-meter, or ton/m3, or kg/m3. Even more specifically, the present invention teaches means and methods to increase the productivity using the concept of Traveling Seed Amplifier, TSA, to enable continuous flow farming of material products, MP, including PMP, and CMP, and synchronous planting and harvesting and novel means to compress vertical space and time required for MP growth.

Prior Art Agriculture Methods

As is well known, since its invention, agriculture is generally practiced in the form depicted in FIG. 1A, comprising the essential elements of food production: i)—the sun; ii)—2D field, an area covered with soil that mechanically and physiologically support plant growth; and iii)—water irrigation source, and nutrients. This is referred to as arable land that combines adequate quantities of sun, water, and nutrients which generally come at no cost. The supplemental nutrients or fertilizers, when added, carry a relatively low cost. As demonstrated by AgriPAL described in CPPA, this form of farming has been profitable because the main ingredients come at little or no cost.

In recent years, the adoption of indoor controlled environment agriculture, CEA has increased. An exemplary prior art reference is U.S. Pat. No. 3,931,695 which gives a good description of CEA. In CEA, the growth area is sheltered, making the control of many plant growth parameters possible, thereby achieving higher yields and higher resource utilization efficiencies. The increased use of soil-less hydroponic or aeroponics nutrient delivery practices increased the economic viability for growing many plants. FIG. 1B illustrates the elements of CEA, also referred to as greenhouse. When solar illumination is used, CEA is the same as conventional sheltered farming with the added benefit of protection from the weather and better control of pesticides, nutrients, and water. When temperature control is added, yields can be enhanced and many planting cycles become possible year round. When artificial lighting is used, extending growth periods to 24 hours per day becomes possible.

Applying AgriPAL has shown that this growing method of farming, while growing in acceptance, is economically viable for certain high value added plants. It is not possible to economically (profitably) produce staple crop or biofuel using indoor farming because of the added daily energy consumption for heating or cooling, and the cost of the added infrastructure. The objects of CPPA, related applications and present invention are inventive aspects that make indoor farming viable even for staple foods.

Most recently, Van Gemeret et al. taught 3D farming system in US Publication 2011/0252705, Oct. 20, 2011 which is depicted in FIG. 1C. The system resembles stacking many edifice floors vertically, resembling the greenhouses in FIG. 1B but placed one on top of the other. The most prominent features of this vertical farming concept are: i)—higher productivity per unit area; ii)—the plants in each floor are independent of the plants of neighboring floors; iii)—the floors do not share resources (light nutrients) directly; iv)—constrained to use only artificial lighting; and v)—the ceiling height, h, of each floor makes the system highly inefficient in terms of productivity per unit height. The economic viability is possible only for high value added products like tulips, cut flower, etc. As will be shown in more details, the present invention addresses these limitations, by means of making growth layers in the form of networked strings that are coupled to each other sharing light, and nutrients, thereby compressing the vertical height needed for growth by factors ranging from 5 to 50. The layers form parallel planes that have interlayer spacings that vary according to plant age. In addition the TSA concept adds the ability to compress the plant planting and harvesting cycle time by factors ranging from 10 to 100 and even higher.

There are numerous other proposals for 3D vertical farming, but none addressed the issues of cost reduction, understanding photosynthesis energy efficiency, vertical space utilization efficiency, and other resource efficiencies, in order to make staple food and biofuel production economically feasible. More specifically, they do not meet the AgriPAL profitability condition, Eq. (2) except for very high priced products, i.e., for

$$\frac{\overline{ROE}}{\overline{COE}} > 100.$$

FIGS. 1D-1H illustrate prior art plant growing methods having distinct environments, (elements) 50a-50e, each of which comprises, a plant 53 illuminated by the sun 51. They are distinguished by the type of growing medium, the plant to mechanical support, and the method of delivering nutrients to the plants. In the case of elements 50a, 50b and 50e, the soil provides the support and nutrients are delivered directly to the soil which are them up taken by plant roots.

In the case of element 50c, the hydroponic method well known in the art is used comprising, a mechanical structure 54, (container) for growing one or more plants. The container is filled intermittently (or continuously) with nutrients 55 and the plant up takes the nutrient through a porous root supports structure, 52a. This root support structure replaces soil.

The aeroponic method, 50d, also known in the art, comprises a plant support structure 56, through which the roots penetrate to bottom space 57c, where the roots are sprayed directly by means of nozzle 57. This method is known to achieve better yields than the soil based and the hydroponic systems because the roots are in direct contact with the ambient oxygen. Its main disadvantage is the low vertical space utilization efficiency and the spray nozzle clogging. In all the prior art cases, the roots are fed by a plurality of different physically separated components (discrete instead of integral components). Also all of these elements feed the roots indirectly from the bottom.

Another key aspect of the present invention is an integrally formed growing element called SansSoil Growing Element, SGE. It is self-sufficient in the sense that it integrates many essential functions for growth in the smallest space and a lowest cost. One distinguishing feature is the direct delivery of nutrients to the plant root from top down, instead of spaying the root from the bottom up. The integral multifunction constructs of the SGE's enable their connection into strings and 3D network of strings that will save space and resources by sharing resources. The inventive aspects of the SGE are key reason for cost reduction to enable staple economical food farming satisfying AgriPAL condition even when

$$\frac{\overline{ROE}}{\overline{COE}} ∼ 1.$$

The construction and functions of the SGE and their interconnection into networks of stings is the main object of the present invention, especially its role in the economic production of TSA and continuous flow agriculture.

The network of strings, forming multi-layer 3D systems, is further distinguished from prior art by the inventive permeability feature of said multi-layers. Layer permeability is defined as the ability to pass through to neighboring layers, light (transparency) and nutrients, received from other neighboring layers. In addition, the shoots and roots of one layer may pass through neighboring layers. This enables the roots of one layer to share the space of the shoots of a neighboring layer below it. The end result is high utilization efficiency of the vertical space by compressing the interlayer spacing needed. The light transparency feature reduces the number of artificial illumination sources as well as the energy consumption.

Liabilities of Soil Based Outdoor Agriculture

In the above, we discussed the high cost of the involuntary dependence on solar energy; enticed by the zero cost to ensure economic viability outdoor farming. One of the consequences is forcing conventional agronomy to succumb to accepting ˜0.5% and as low as 0.1% efficiency, TABLE 1. This afforded little or no control over the energy efficiency, η_{E}, to make further improvements beyond what has already been achieved in the last 50 years, ˜20 times yield improvements, the fruits of the Green Revolution that started in 1950s.

Going forward, perhaps only fractional gains may be realized, which are offset by higher per capita demand. The low efficiency and lack of control of nutrients, and other elements in outdoor solar-based and soil-based farming have lead to the requirement of enormous resources that are used inefficiently including: insatiable demand for two dimensional arable land, water, fertilizers, and pesticides.

In Section II of my CPPA-1, I presented a number of examples highlighting the challenges associated with growing staple commodity foods indoors, and why that is not possible if one relied of the limited prior art understanding of the efficiency, η_{E}, concluding that outdoor field soil-based farming is the only presently available viable option for growing staple food to feed the world, and growing biofuel, energy for transportation. The inventive contributions of my CPPA and the present application change all that with new transformational framing paradigms.

The viability of present outdoor option is dependent of the continuous reliance on the zero cost solar energy, and its associated drawbacks or requiring vast resources that are not utilized efficiently. In addition, the outdoor farming constraint, subjects the growers to other consequences; environmental and economic risks, unexpected crop losses due to microscopic pathogens, weeds, droughts, floods, and extreme unseasonable temperature variations.

### OBJECTS OF THE INVENTION

In order to solve the formidable food and energy problems and challenges facing humanity and eliminating the contradictory conflicts, a transformational departure from conventional agricultures is needed. Conventional agricultures is constrained to be in the outdoor open field environment. This constraint is a consequence of the reliance on zero cost of solar energy, CO2, and water for photosynthetic to produce biomass for food and energy. The path to the solutions of the aforementioned problems is abandoning outdoor soil-based agriculture that requires enormous supplies of arable lands and water resources. Following this new path provides great benefits which include: eliminating the lack of control over nutrients, 1000 times water saving, eliminating adverse environmental conditions, and soil-borne pathogens.

Instead of conventional two dimensional, 2D, outdoor farming, the object of this invention is to teach means and methods to profitably harness the third dimension where unlimited space is available, where soil is avoided, and water can be conserved. The inventive 3D agriculture according to the present invention focuses on utilizing the third dimension efficiency by teaching devices, systems and methods to compress the vertical space needed for food production.

The teachings according to the present invention of 3D farming is the partitioning of the third dimension into a plurality of layers (multi-layers) each of which is capable of being supplied with nutrients, and the light needed to sustain growth. Said plurality of layers are supported by means of a 3D structure that comprises a master system comprising subsystems which are designed to optimally provide water, light, nutrients, CO2, O2, and temperature controls for specific plant organism species.

Said plurality of layers comprise strings of interconnected soil-less (SansSoil) growth elements, SGEs, each of which is integrally made to have a multi-function capability including: germinating the seed, growing the plant, providing the plant with physical structural support, water, nutrient, light, and capability to sense the plant environment.

The strings of SGEs are disposed in the first, second and third spatial coordinates. They are in the form of one dimensional network, two dimensional network or three dimensional network supported by the multilayer structure.

An aspect of the invention is resource utilization efficiency such that staple foods and bio-energy are produced profitably so that the food and energy supplied with no “food or fuel” competition problem. This is accomplished by means of inventive features described herein that enable the plants in each SGE in string networks to share resources including: light, nutrients, and intra-layer space. This is the multi-layer permeability property taught according to the present invention.

Another aspect of the present invention is making each SGE and the string interconnection and space between strings optically transparent, permeable, so as to enable light to pass through plurality of layers to share, conserve and efficiently utilize light. This will minimize the need for many light sources, thereby reducing product cost.

Another aspect of the present invention is the traveling seed amplifier, TSA, concept which enables high through put continuous flow farming of MP, that have wide spectrum of applications including: all foods, biofuel, medicines, and high performance industrial materials. Key features of TSA include the continuous-synchronous or semi-continuous planting and harvesting MPs at high rates, ranging from 1 to 10 times per day, or at compressed time periods much shorter than the specie dependent seed to harvest time, τₛₜₕ.

Another aspect of the present invention is compressing the vertical space resulting in much higher volumetric productivity, ton/hectare/meter, than prior art vertical concepts discussed above, and illustrated in FIG. 1C. According to the present invention, there are at least three ways to achieve vertical compression of the average interlayer spacing hₐᵥ which include: i)—the use of ultra-compact integrally constructed SGEs assembled in string networks; ii)—enabling the shoot-root space overlap; and iii)—the TSA concept which automatically adjusts the traveling interlayer spacing according to the age of the growing plant.

Another aspect of the present invention is providing a totally sealed system for growing plants for food and energy comprising inventive sealing features and mechanisms to recycle water and nutrient resources to maximize utilization efficiency and reducing cost. For example, the natural transpiration of water is recaptured and reused. The plant growth environment is maintained at a desired temperature and relative humidity for optimum plant performance. The result is water saving by reutilizing between 100-1000 times water which would have been wasted in conventional outdoor agriculture.

Another aspect of the present invention is harnessing the limitless vertical space in combination with the TSA and continuous flow agriculture to construct high rise edifices, and tower structures extending upward tens of meters or even hundreds of meters in the sky, enabling the production of MP, food and bio-fuels without competition for space resources, since the vertical space is limitless. The TSA towers may be illuminated by the sun, artificial lighting, such as LED, or a combination of both.

Yet another aspect of the present invention is the construction of TSA towers (Hₛ meter high) in pairs, comprising 2N layers, so that the first tower comprises a planting (input) port at the bottom and the second tower comprises a harvesting port (output) also at the bottom. In operation seed or seedling layers are inserted in the planting while mature plant layers are synchronously harvested from the harvesting port. To accomplish this synchronous continuous flow farming, a transport means is provided to transport the layers from the planting port to the top of the first tower, transferring layers laterally to the top of the second tower, and finally transporting the layers downward for harvesting at the bottom harvesting post of said second tower.

Another key aspect of the present invention is TSA tower pairs featuring vertical compression factors in average interlayer spacing, hₐᵥ, ranging between 2 and 10, and temporal compression factor,

$${τ}_{h} = \frac{{h}_{av}}{2 {H}_{s}} \frac{{τ}_{sth}}{N} ,$$

speeding up the synchronous planting and harvesting periods by 10 to 100 times and even 100-1000 times, where.

Yet another aspect of the present invention is TSA tower systems aseptically sealed by providing load locks to the planning and harvesting ports and automation means to control physiological and environmental and physical parameters for optimum MP growth conditions.

Another aspect of the present invention is the isolation of the sealed 3D growing TSA tower system from the external environment thereby protecting said environment. This is especially beneficial when growing genetically transformed plant species (GMO) for experimental and production purposes.

### BRIEF DESCRIPTION OF THE DRAWINGS

The following drawings are intended to describe the preferred embodiments and operating principles. They are not intended to be restrictive or limiting as to sizes, scales, shapes or presence or absence of certain necessary components that are not shown for brevity but are, nonetheless, well known to those skilled in the art.

FIGS. 1A-1C describe prior art farming methods: Outdoor soil based farming, Indoor CEA (greenhouse) farming and 3D vertical farming

FIGS. 1D-1H illustrate the various environments which plants grow into and specifically how nutrients are delivered to the plant roots.

FIG. 2A illustrates a SansSoil indoor farming system comprising a protected environment for sustaining plant growth, and a control subsystem that follows a program to control the growth.

FIG. 2B-2C shows more details of the system 1, that is comprised of multilayer each of which comprises a network of strings of SansSoil Growth Elements, SGEs. The graph shows the localization of each element in the 3D space, first, second and third spatial coordinates, and how they periodically repeat with periods pz, py, pz.

FIG. 2D-2E describe more details how each SGE is made, its structures and function.

FIGS. 2F-2K describe how SGE are interconnected into strings, which in turn from layers of plurality of strings all networked to from a 3D growing system 1.

FIGS. 3A-3H describe the integrally made single SGE and its commutations with its neighbors sharing resources: light and nutrients to support growth.

FIGS. 3I-3M describe the integrally SGE and SGE strings assuming growth plants in various orientations.

FIG. 3N illustrates the possibility that strings of SGE may interconnected into series and parallel network combinations in communication with resource supply sources.

FIG. 3P show exemplary plurality of configurations to attach SGE to supply sources, and to neighboring SGEs.

FIG. 4A describes multi-layer permeability of light, enabling layers to share light from common source.

FIGS. 4B-4C, describe the multi-layer permeability of shoots, and roots sharing space of neighboring layers.

FIG. 4D illustrates the multi-layer permeability to fluids delivering nutrients to plants from a common source. The fluids are in the form of fog, mist, sprays, and streams.

FIG. 5A describes the multi-layer tower traveling seed amplifier, TSA, concept for continuous flow agriculture.

FIGS. 5B-5E describe typical plant growth trajectory curves, defining key parameters to illustrate the inter-layer vertical space compression concept of TSA.

FIG. 5F describers the flexibility in locating the planting and harvesting ports attached to the TSA tower housing.

FIG. 5G describes a variation of TSA concept wherein the layers move horizontally instead of vertically.

FIG. 6A-6B illustrates the variable pitch screw TSA transport mechanism which automatically maintains appropriate interlayer spacing according to plant age.

FIGS. 6C-6F describe the reduction to practice of TSA system concept, showing the various key components.

FIGS. 7A-7D are illustrations of a composite TSA layer comprising a plurality of trays in the form of 2D SGE arrays for cell cultures on super-hydrophobic coatings.

FIG. 8 describes the diverse energy sources which may be used to drive the operation of the TSA tower, to drive strings of LED, control the climate and to deliver nutrients to sustain plant growth.

### DESCRIPTION OF THE PREFERRED EMBODIMENTS

Multi-layer Continuous Flow Farming High Photosynthetic Efficiency

In my CCPA, I described transformational new paradigm for agriculture which can be realized to solve the problems facing humanity and achieve food and plant based energy security. One key feature of the new paradigm is the understanding the profitability conditions of farming. This has been accomplished by the formulation of Agriculture Profitability Assurance Law, AgriPAL, it is repeated here as Eq. (2)

$${η}_{E} ( \frac{{ɛ}_{sol}}{{ɛ}_{other}} ) \frac{\overline{ROE}}{\overline{COE}} \geq ( 1 + p + f + v ) . \qquad ( 2 )$$

AgriPAL enables an enterprise to predict profitability of plant growing systems, to determine pricing of products, and to identify efficiency bottlenecks.

The economic viability index, EVI, is defined as:

$$EVI ≡ {η}_{E} ( \frac{{ɛ}_{sol}}{{ɛ}_{other}} ) = {η}_{E} {g}_{solar} .$$

This links for the first time the economic parameters of farming, profit, p, fixed cost, f, variable cost, v, to the physiological parameters of organisms (plants, algae, other phototrophs), energy conversion efficiency, η_{E}, including a gain factor,

$${g}_{solar} = ( \frac{{ɛ}_{sol}}{{ɛ}_{other}} ) ,$$

wherein, δₛₒₗ, is the solar energy consumed per cycle and, εₒₜₕₑᵣ, all other energies consumed.

An enhanced EVI, was derived from a the new Plant Growth Model, PGM, also described in CPPA-1, is given by: EVI^{e}≡η_{E}^{e}≡gₑη_{E}. This increases the efficiency by yet another gain factor, gₑ, which can be 10-100, achieved by means of controlling and optimizing physiological growth parameters as well maximizing the temporal and spatial resource utilization efficiencies.

The present invention comprises aspects of AgriPAL that deal with maximizing space utilization efficiencies, which include three dimensional, 3D, soil-less, SansSoil, plant growing structures and subsystems to sustain growth. More specifically, the aspects that reduce the cost of said structures and subsystems which lead to the minimization of the parameter f in Eq. (2). Even more specifically, the increase of gₑη_{E} which is a function of the n, the number of vertical layers in 3D farming systems wherein the productivity and yield are measured in units of ton/hectare-meter-year, or ton/m3-time, or kg/m3-day.

The preferred embodiments, in the present application, deal with growing plants in 3D space that is limitless. More specifically, 3D space including, growing plants in 3D edifices, structures, or towers of heights, ranging from 10 meter to 100 meters, and even more preferably tower heights beyond 100 meter perhaps approaching 500 meter or even 1000 meter. Buildings having heights exceeding 500 m already exist, validating that structure engineering technologies are advanced and can be harnesses for our high rise faming architectures. As is well known, making wind turbine tower as high 150 m is economically feasible.

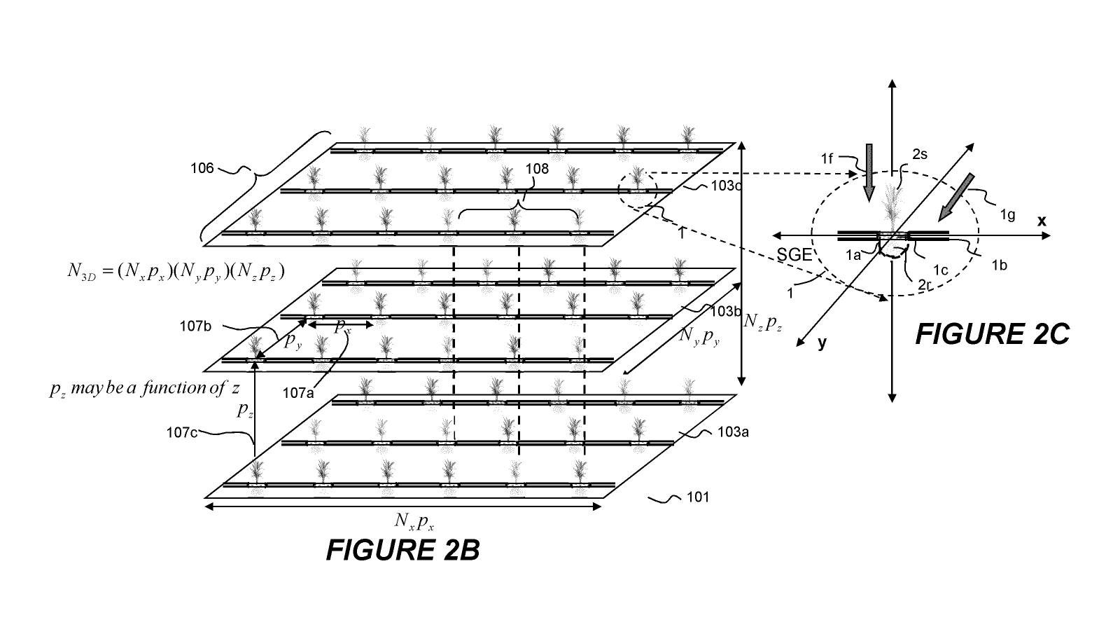

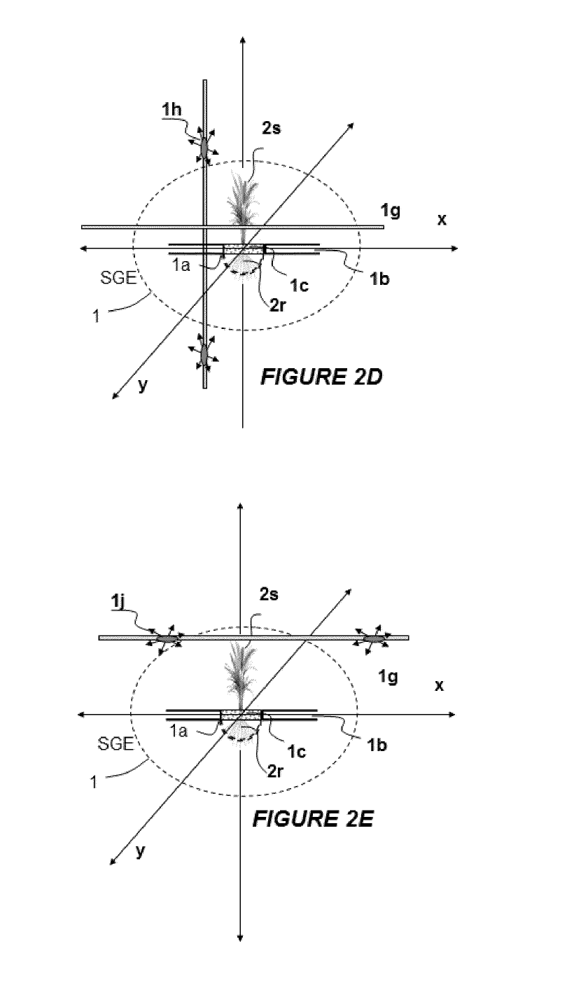

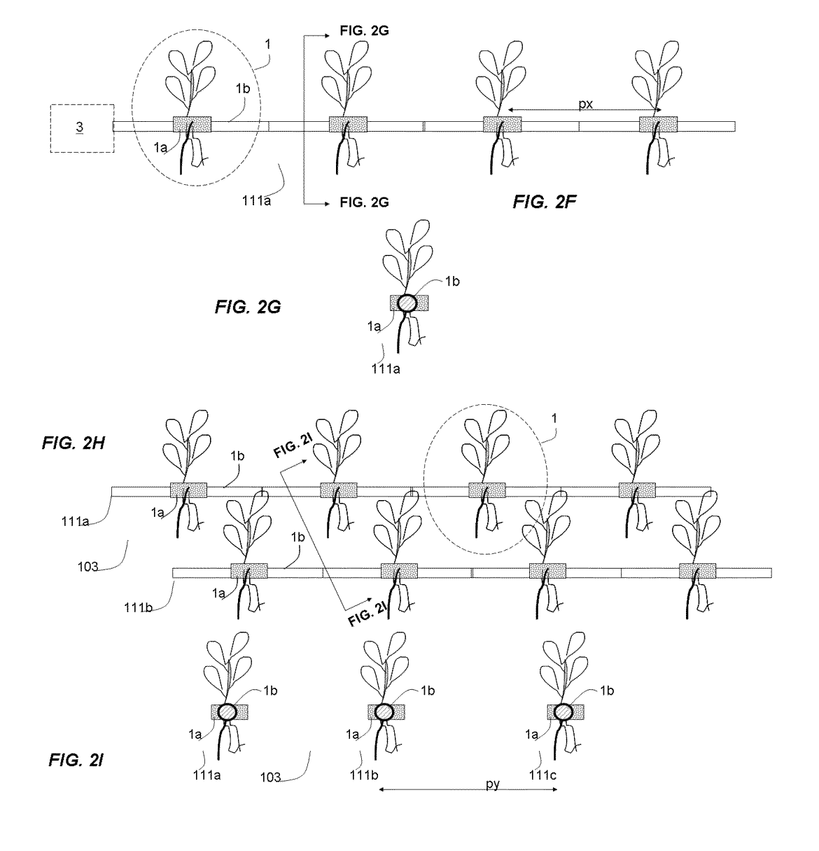

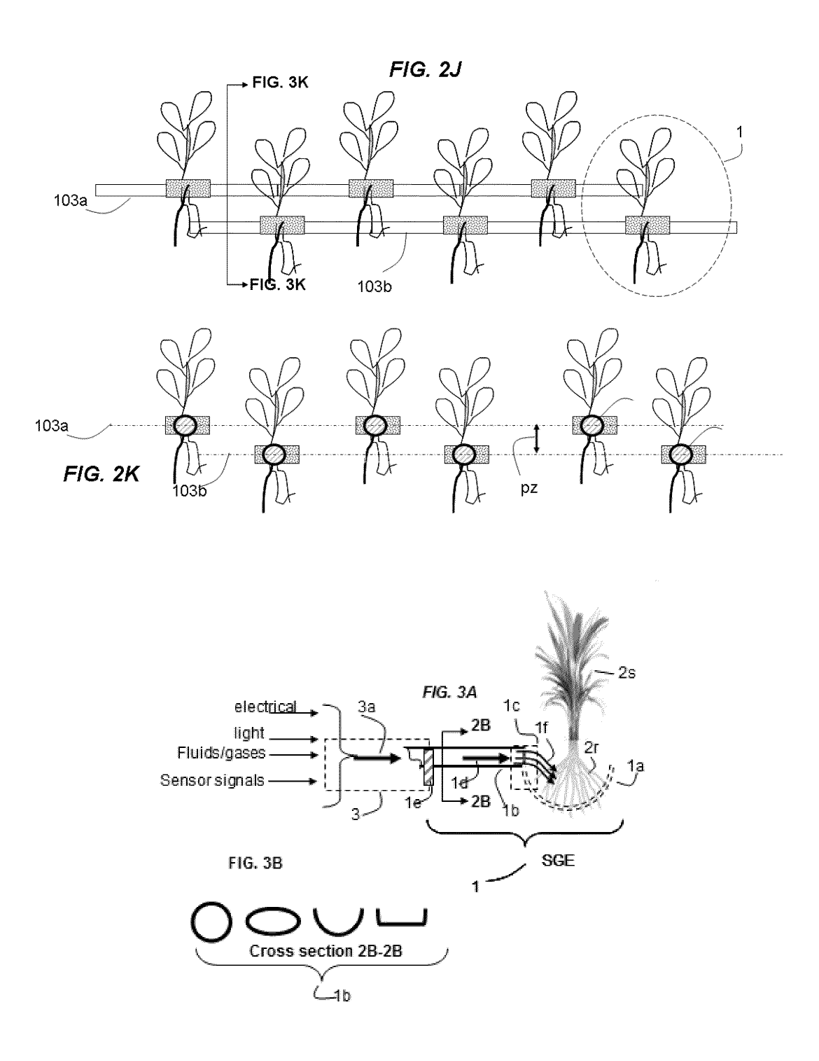

FIG. 2A is an exemplary depiction of an indoor SansSoil farming system 100, comprising a SansSoil sheltered and protected controlled environment 101 and a control subsystem 102. The SansSoil sheltered and protected controlled environment 101 is designed to be substantially impermeable to pests, and undesired gases, liquids, particulates, and other foreign objects. Preferably said protected environment is well insulated and protected from outside temperature swings in order to maintain a desired temperature that is most suitable for growth and results in maximum productivity.

In certain situations, solar radiation may augment artificial light for photosynthetic growth. In this case, the SansSoil environment 101 may be equipped with filters to filter out unwanted solar wavelengths including ultra-violet, infra-red and certain visible wavelengths.

The hybrid growth method based on the combination of artificial lighting, preferably LED, with selected solar wavelengths, will enable the maximization of gₑgₛₒₗₐᵣ, viability index and the profit margins established through meeting the AgriPAL condition as described in CPPA-1

The SansSoil environment also comprises structures for handling, planting seed/seedling in the input port, 105, also referred to as the planning port. The mature plant product is harvested at the output port, the harvesting port 104. Said structures are preferably designed to incorporate appropriate sealing structures such as load locks in order to maintain sterile or near sterile conditions. Means to achieve impermeability and sterility of SansSoil edifices are well known to persons skilled in the art. Internally, the SansSoil environment 101 houses a plurality of SansSoil material product, MP, growth layers 103 disposed in a three dimensional space. The SansSoil MP layers are made form structures and materials that are optically transparent. This will enable the layers to share and recycle unabsorbed light, thereby increasing the light energy utilization efficiency.

The present invention is generally related to growing or amplifying martial products, PM, including, PMP, and CMP. The specific use of the word plant, as in plant layers, and plant growth elements, is not meant to limit the scope of the broad inventive features that apply generally to a broad spectrum of growing material products.

The control subsystem 102 is programmed to control all aspects of growth physiology to achieve economic viability by ensuring that

$${EVI}^{e} = {g}_{e} {η}_{E} = ( {G}_{sp} {G}_{t} {G}_{f} ) ( {\prod }_{i = 1}^{n} {g}_{i} ) {η}_{E}$$

approaches or exceeds 1 in order for AgriPAL condition to be satisfied. Each gain parameter in the portfolio has an optimum range that gives the maximum value. This is adjusted by the subsystem 102 for each species. The upper and lower limits of this range are determined experimentally in optimized environmental parameters.

In some situations, a group comprising more than one interacting parameters, may be adjusted and optimized together. For example, adjusting the carbon dioxide to an optimum value limited by the dark reaction enzyme density requires adjusting the light level until it is limited by the light reaction enzyme density. The steps of optimization are aided by appropriate sensors which communicate with the controller values that require adjustments.

The Integral SansSoil Growth Element

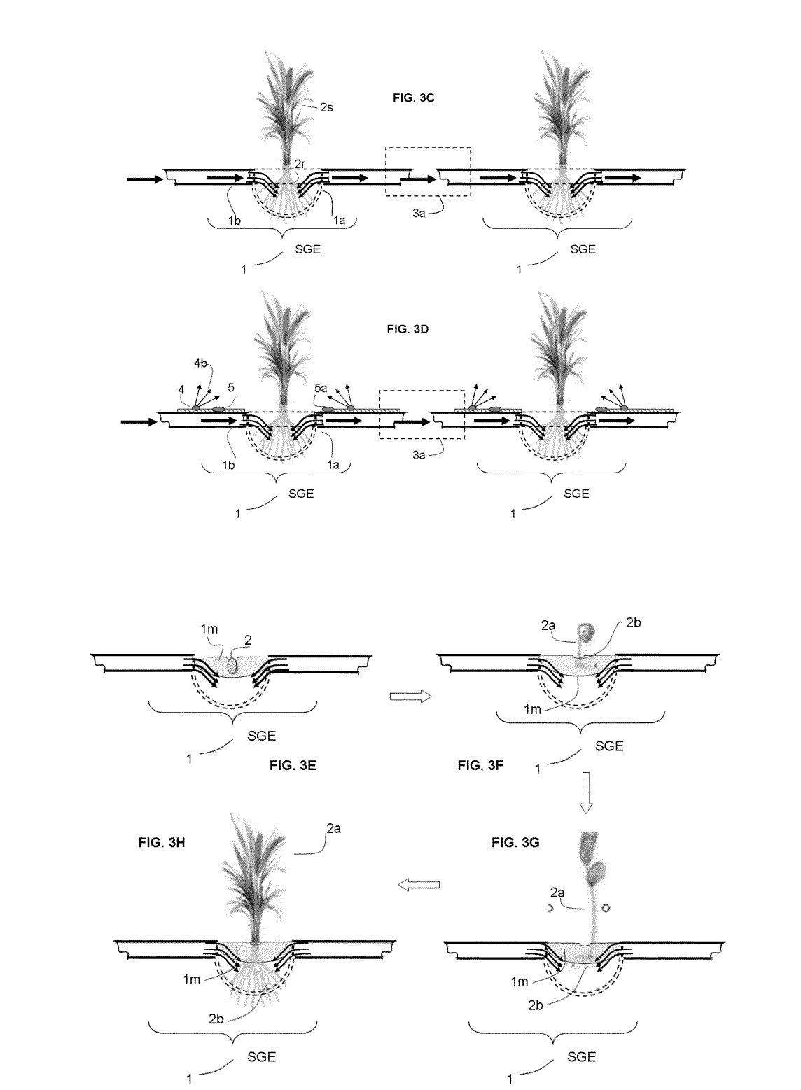

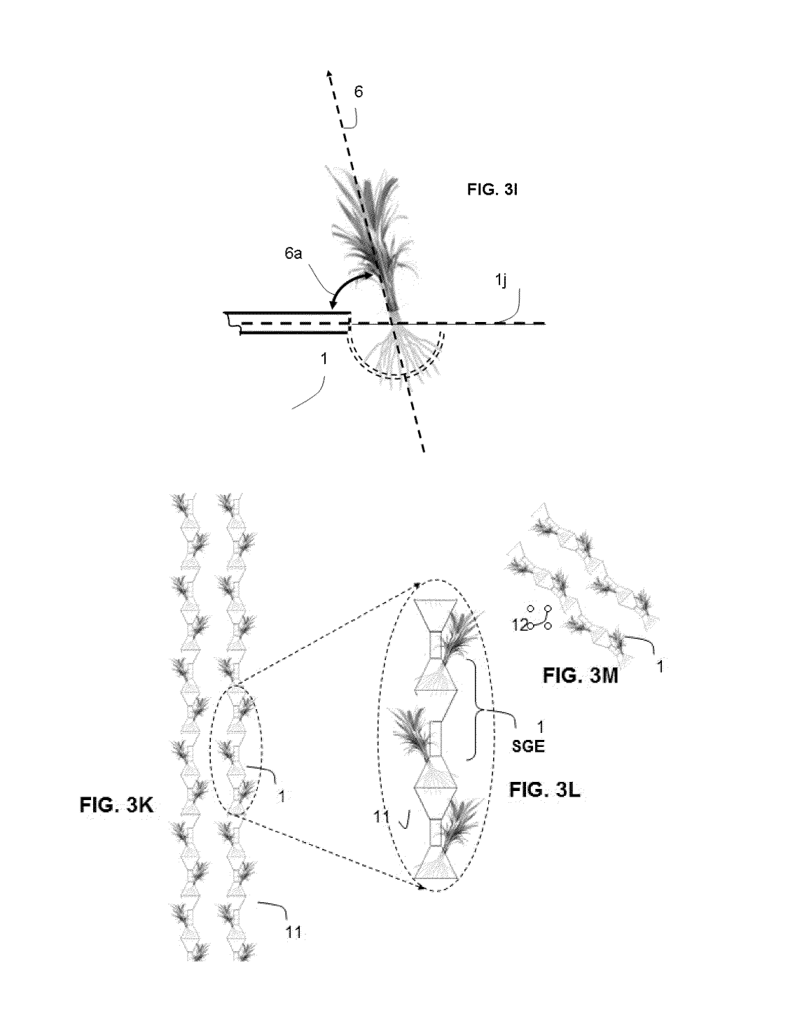

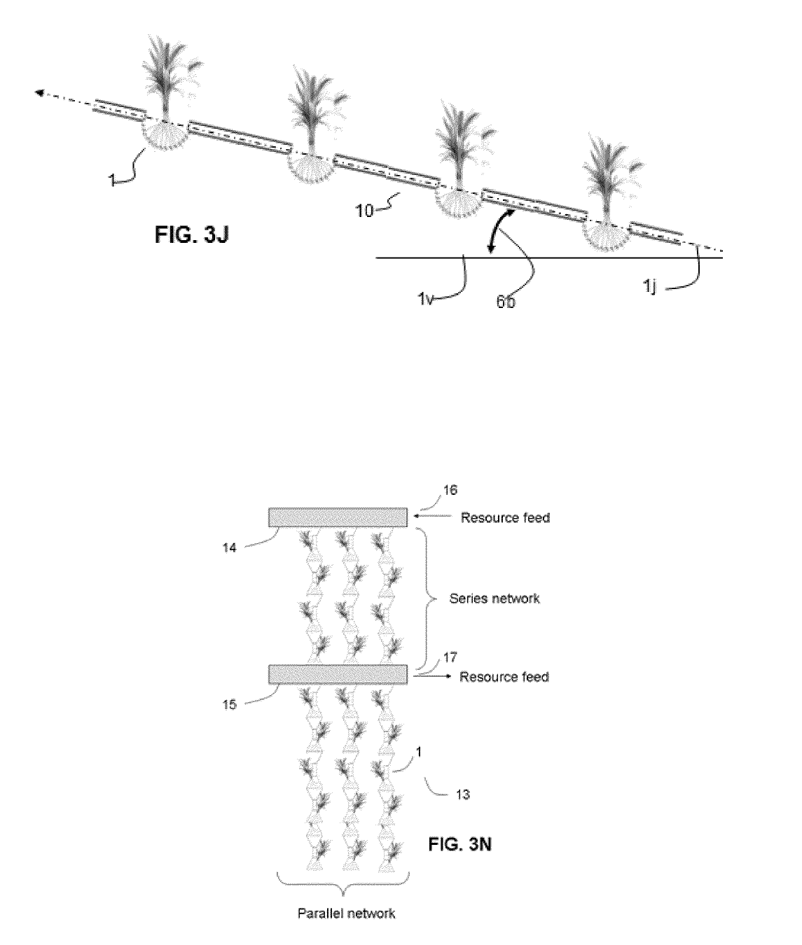

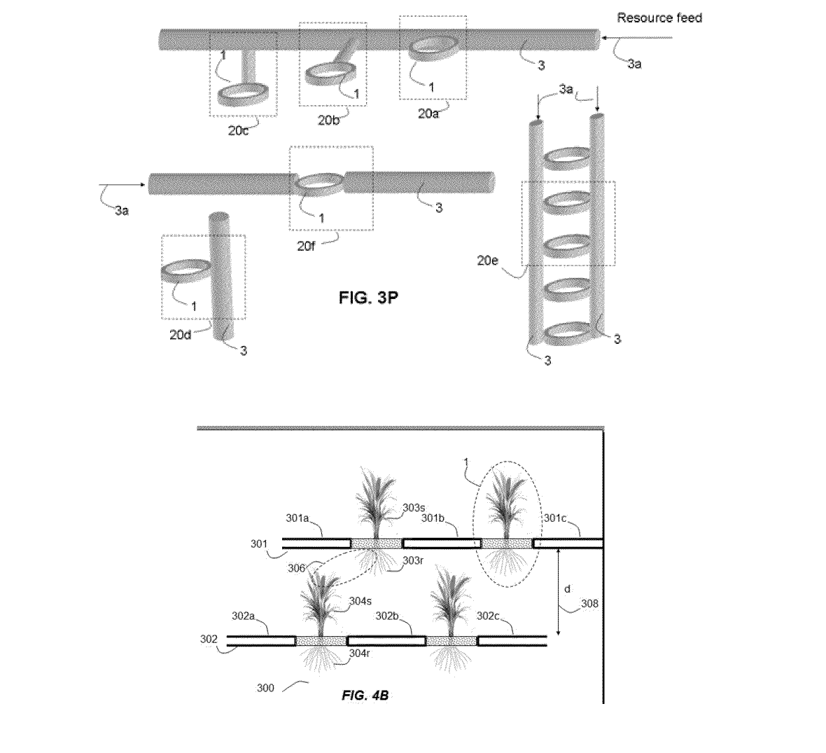

Each layer 103 within the SansSoil environment 101, is so designed to sustain the growth of plants or organisms in integrally made SansSoil growth elements (modules), SGE 1, described further in FIGS. 2B-2K, and FIGS. 3A-3P. The layers 103 and the plurality of SGE's are spaced in such a manner that optimizes the space utilization efficiency Gₛₚ.

Each SGE 1, comprises integrally made structure 1a, 1b which houses the plant 2, the shoot 2s, and the root 2r, and connected to a nutrient sources 3, 3a. The nutrients drip or spray downward on the root in the cup like substructure. One key aspect of the present invention is to combine this method of feeding, with foliar feeding, well known in the art. This is accomplished by means of fogging subsystem (or mist), which preferably supplies micron scale fluid particles (droplets) that are absorbed directly by the plant leaves, by-passing root uptake. Each SGE 1, optionally and integrally comprises a light source 4, and a sensor 5.

It is also possible to have two fogging systems, one for supplying one set (a first set) of nutrients to the root and a second supplying different nutrient set to the leaves. In addition to providing more that one feeding sources, it is contemplated that in certain situations, said sources may be applied sequentially, or in a temporally pulsed manner with adjustable periods and duration.

This inventive feature is unique to indoor farming, according to the present invention, because it affords a new degree of freedom for the subsystem 102 to control the components of gain factor gₑ, through optimization of the operating range of each component. This is especially advantageous when two sets of nutrients are antagonistic to each other, competing to prevent the optimum pH to establish for maximum beneficial uptake.

FIG. 2B shows that in each of layers 103a, 103b, and 103b, the SGE's (FIG. 2C) are connected in strings 106, that are connected to nutrients sources delivered to each SGE site. In the first spatial coordinate, x, the SGE repeat at period px, 107a, while the strings repeat in the second coordinate, y, at a period py, 107b. In the third spatial coordinate, z, the layers repeat at period pz, 107c. The dashed lines 108 depict columns of SGEs in there respective layers. The total number of plants in the 3D system, N_{3D}=(Nₓpₓ)(N_{y}p_{y})(N_{z}p_{z}), determines the over all 3D productivity of the system 100.

The illumination sources 1h, 1j and auxiliary sensors, 1g, or other resource, are disposed in any orientation relative to the three spatial coordinates, FIGS. 2C-2E.

As shown in FIG. 2F, a plurality of SGEs are connected as a linear string 111a, which is connected to a sources 3. The connection structures are so designed to deliver, with high conductivity, nutrients to each site 1. Preferably, these structures are designed for quick connection to the SGE, enabling rapid and inexpensive and automated means to form a long string. These structures also have the strength to spurt the weight of the plants in the string. FIG. 2G shows a cross section of a typical string.

In FIG. 2H, many strings 111a, 111b, are placed in parallel to form a layer 103. The cross section FIG. 2I illustrates one of the permeability feature of the present invention, namely, the empty space between strings. This empty space enables the sharing of nutrients, light that pass through between the strings and between the layers. This permeability also includes the ability of shoots and roots to overlap, share the same space.

The advantages of the string interconnections is further highlighted in FIGS. 2J-2K wherein two layers 103a, 103b disposed vertically, each comprising a plurality of strings. One immediately notices the space saving in the cross section FIG. 2k where the plants of layer 103b, is in the space of the top layer 103a. The space between two layers is pz. It will be show later in a different embodiment that the period pz, interlayer space, can be made to vary, plant manually or automatically, depending on the plant age.

The plant age or the growing material product age is defined as the time that has elapsed from an embryonic time, an initial time, corresponding to an initial material mass size. This initial material may be seed, seedling, embryo, initial cell culture or initial microorganism micro-organism culture. The initial age of material product, MP, is the initial time τᵢ, having an initial mass, m, which grows to a final age, final harvesting time, τ_{f}, having an amplified final mass, M_{f}, in a seed to harvest time τₛₜₕ=τ_{f}−τᵢ. The mass gain realized during this period is given by

$${G}_{sth} = ( {M}_{f} ( {τ}_{f} ) - {M}_{i} ( {τ}_{i} ) ) / {m}_{i} ( {τ}_{i} ) = \frac{M ( ∞ )}{{m}_{i} ( {τ}_{i} )} {e}^{- {k}_{t} {τ}_{i}} ( 1 - {e}^{- {k}_{t} {τ}_{sth}} ) ,$$

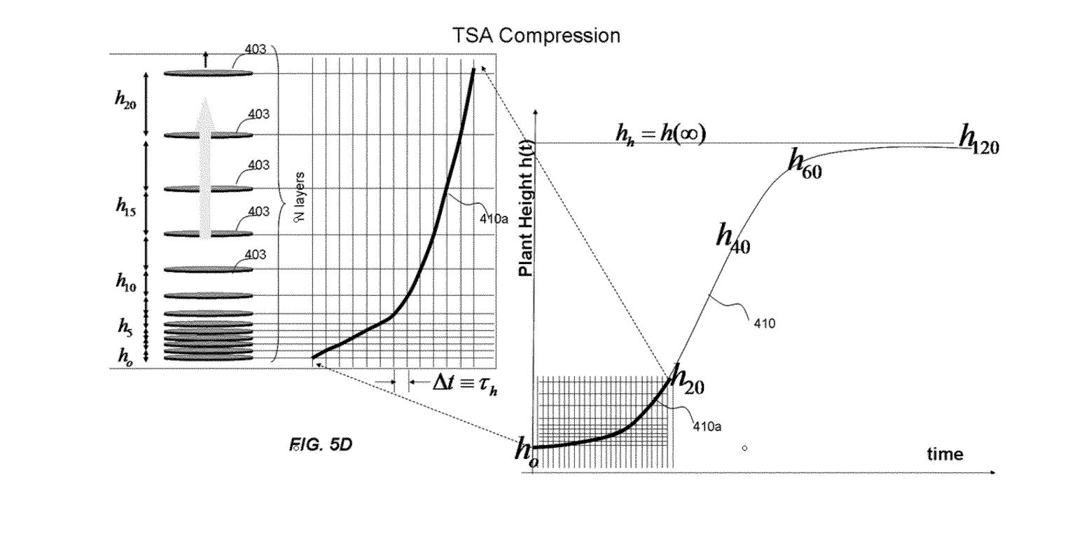

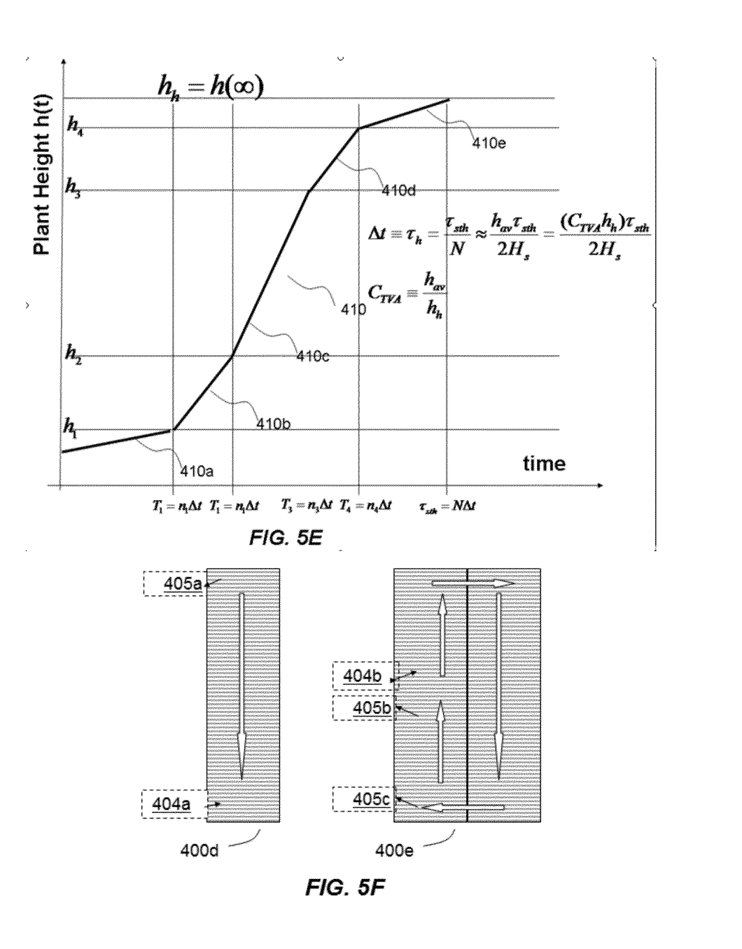

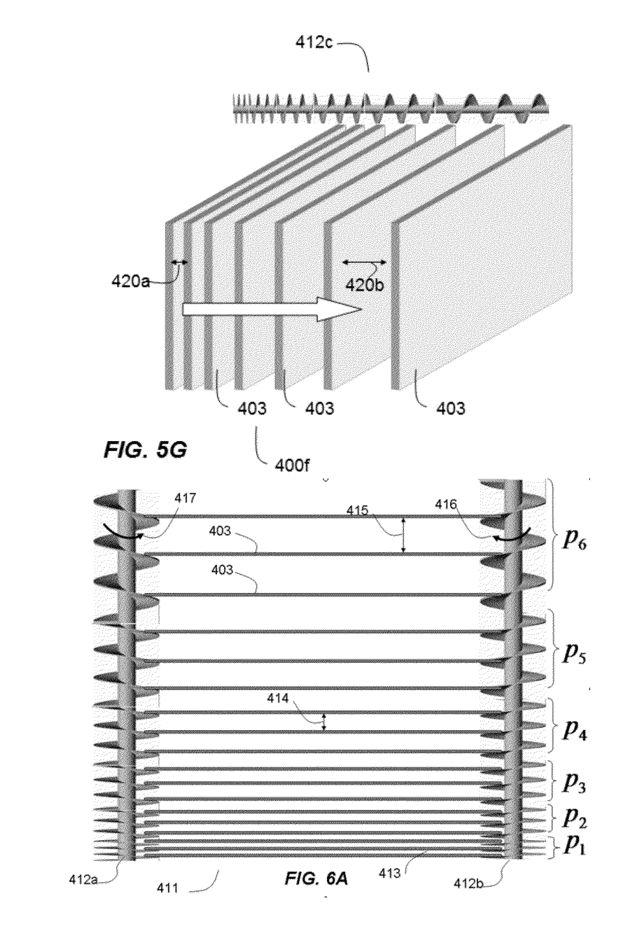

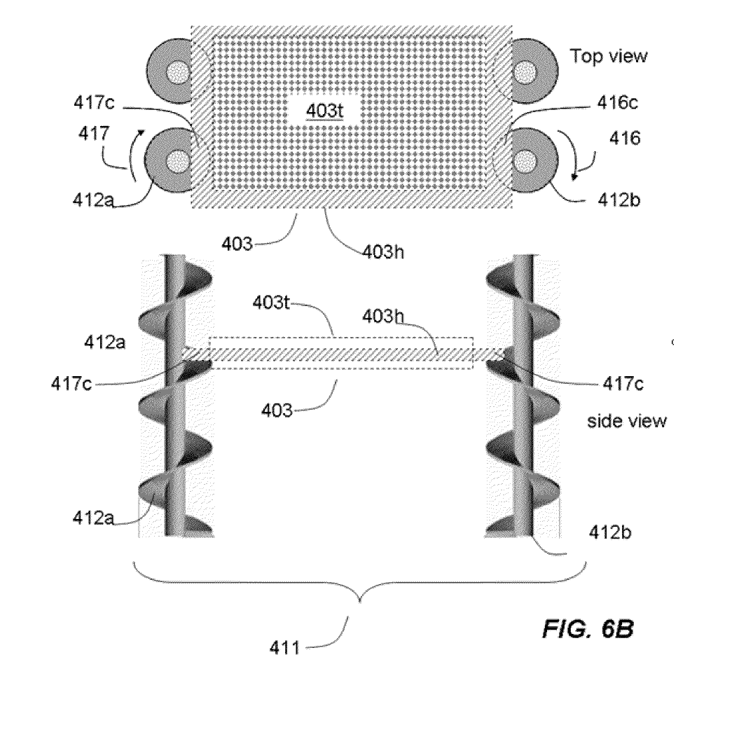

as derived in FIG. 5B.

Now we provide in FIGS. 3A-3P more specific details of the construction of the SansSoil Growth Element, SGE. The term integral multifunction is defined as a structure that comprises at least two substructures integrally made, substantially permanently attached, so as to carry out at least two functions. These functions are chosen from the group: {mechanical support, growth sustenance, germination, self-supplying nutrients, self-supplying light, sensing environment, communication nutrients to nearest neighbor}.

The SGE in FIG. 3A comprises growth compartment or substructure 1a which mechanically and physiologically supports the growth of the root 2r and the shoot to maturity. The substructure 1a is integrally attached to a connecting conduit 1b, that is in fluid communication with growth substructure 1a, through an orifice or an opening 1c. Fluid 1d, flows through said orifice 1c, supplying a stream 1f to the root. Conduit 1b may have any cross section as shown in FIG. 3B.

Conduit 1b is removably attached to at least one source 3. Said attachment is preferably quick connect disconnect type with sealing function to prevent leakage, 1e. The source 3 provides essential resources, ingredients, to optimally sustain plant growth. Said resources comprise at lease water and nutrients, but may also conduct and deliver light by means of total internal reflection mechanisms, well known in the fiber optic art and the back-light sources well know in the liquid crystal display art. The conduit may conduct electrical signals or power from sensors and to local LEDs ingrated directly into the conduit 1b.

Conduit 1b according to FIGS. 3C-3D, serves to connect two SGEs to form strings as described above, FIGS. 2K-2K, and to pass resources 3a from one SGE to another. Said resources include fluids, conducting signals from sensors 5, 5a, and energizing LEDs 4, to provide illumination 4b to local plants.

As shown in FIGS. 3E-3H, the SGE in the preferred embodiment also comprises a seed support structure lm, which functions to mechanically support the seed 2, and to provide the optimal environment for high germination rate. By following the arrows in the figures, we show the emergence of the shoot 2a and root 2b, the growth of the seedling and finally the mature plant. This emphasizes the significance of the integral construction of the SGE, according to this preferred embodiment, highlighting the capability multi-functions which comprise: mechanical support of seed and mature plant, germination, local nutrient delivery, local delivery of light, environment sensing, and growing plant to maturity, FIG. 3D.

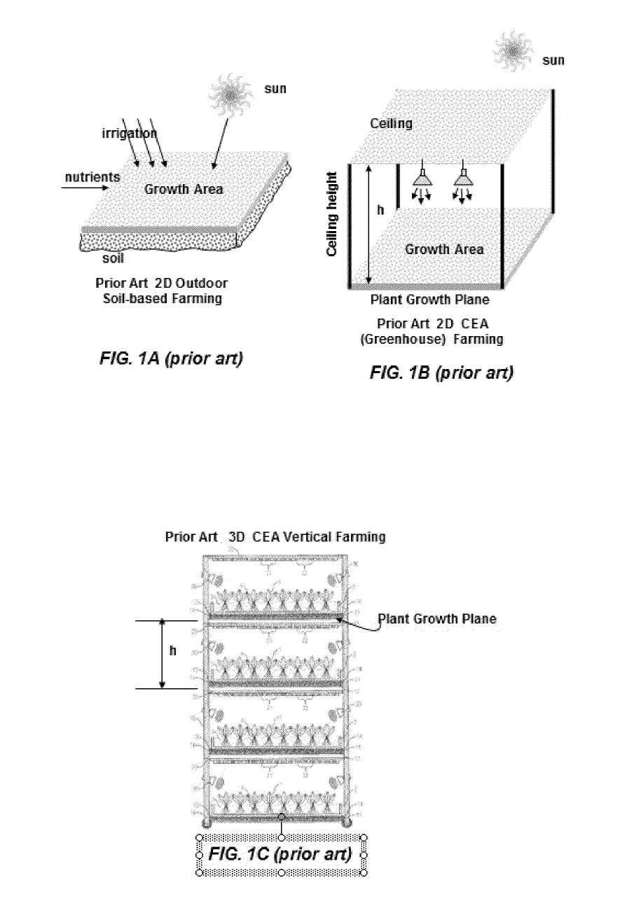

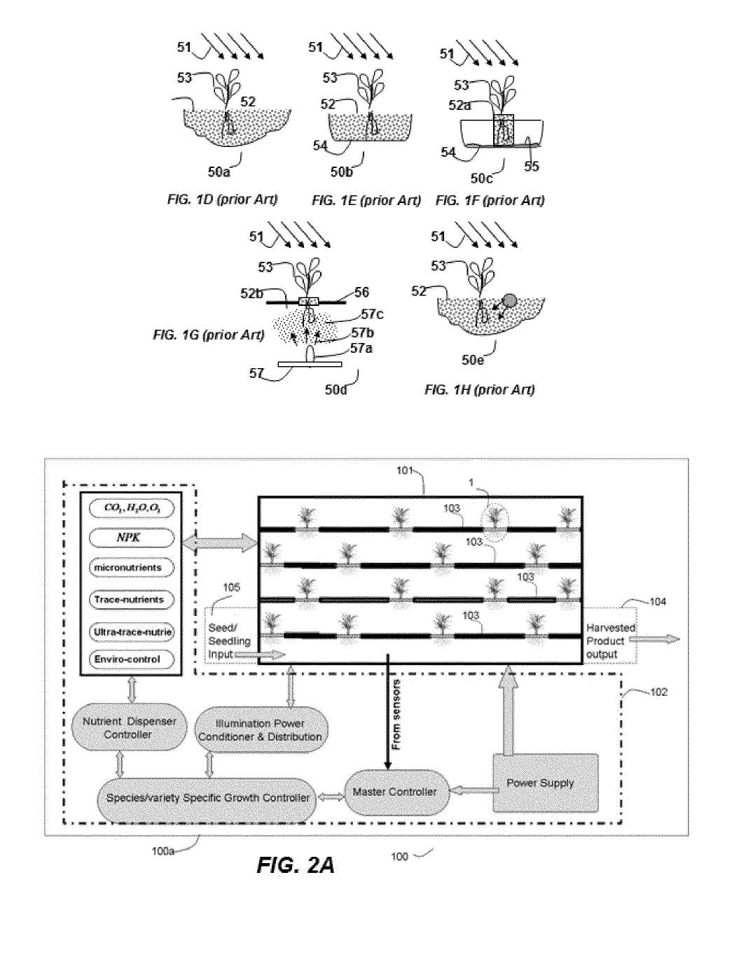

The multi-function integral construction of SGE, also highlights the local self-sufficiency of each SGE, that plays a significant role in maximizing 3D space utilization efficiency. It also serves to make its distinction clear, relative to prior art plant growing practices, described above in connection with FIGS. 1A-1H.

Since the plants follow the light direction, we can advantageously exploit this property to orient the plant growth in any desired direction as illustrated in FIG. 3I, wherein the growth axis 6, makes an angle 6a with respect to the layer axis 1j. In other embodiments, the whole string and plane, 10, may be oriented at an angle δb with respect to the horizontal direction 1v, FIG. 3J.

Yet in other embodiments, it is preferred to make strings that are hanging from top to bottom, 11, 12, with SGE oriented in desired directions determined by the light as shown in FIGS. 3K-3M.

In addition, there are system optimization benefits to interconnect SGE strings in the form of a network, 13, FIG. 3N, that combines series and parallel combinations of strings attached to feeding structures, 14, 15, which receive resources 16, 17 from a master delivery system (no shown). The benefits of this arrangement include: increasing speed and flexibility of system assembly, reducing infrastructure cost, and optimizing consumable utilization efficiencies.

Integrally made multi-function self-sufficient SGE may be attached to feed structure, or string interconnection sutures, 3, in a plurality of desired configurations, 20a-20e, shown in FIG. 3P, depending on the plant species and system design requirements. Persons skilled in the art may produce other configurations, without departing from the SGE network interconnectivity claimed by the present invention.

Multi-Layer Permeability

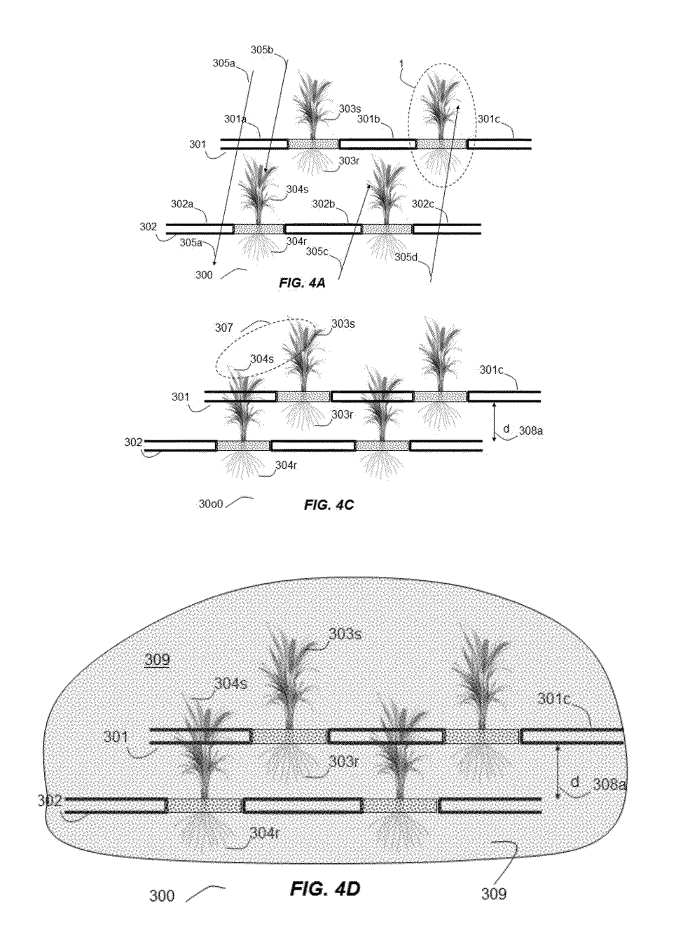

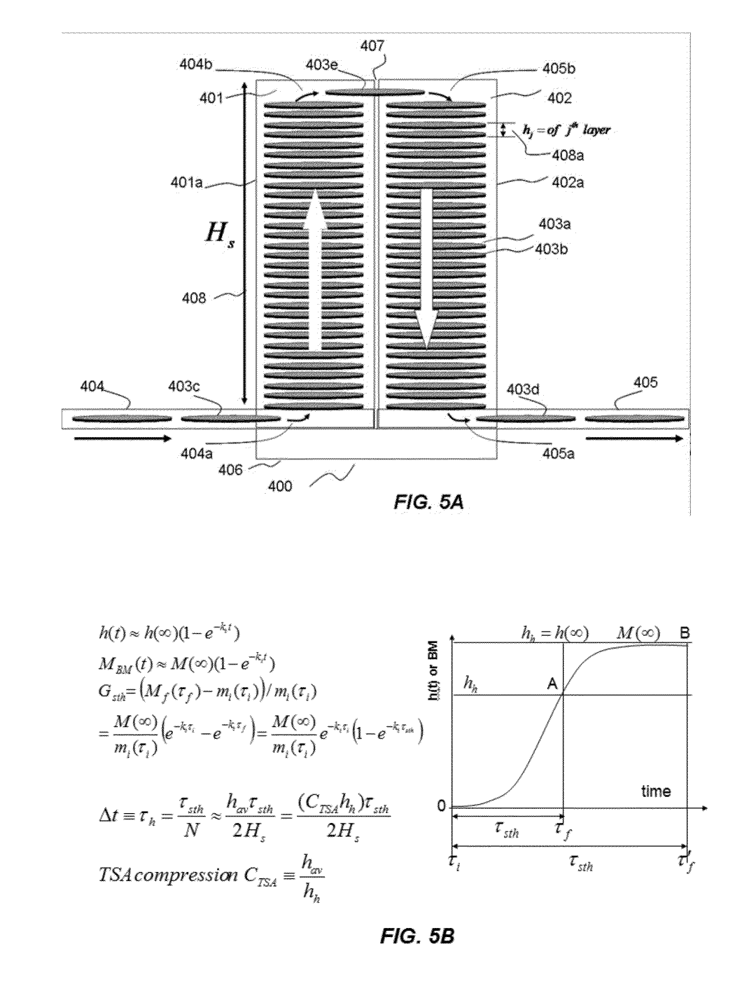

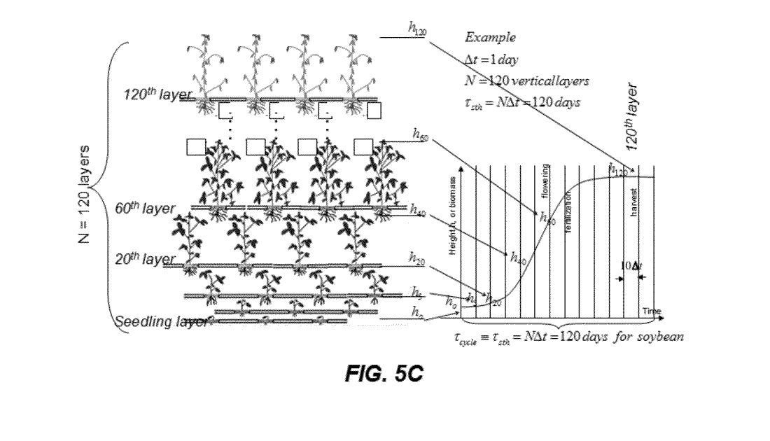

To realize the full potential of 3D multi-layer farming, the preferred embodiments comprise means to maximize resource utilization efficiencies. This is accomplished by means of sharing these resources which include: illumination sources; nutrient delivery subsystems, supporting structures, and space. These means for sharing are described in FIGS. 4A-4D, result in the reduction of the system fixed costs, f, as well as the variable consumable costs, v, thereby ensuring maximum profitability, according to AgriPAL Eq. (2) above.

The definition of permeability, according to the present invention, is the ability of a layer comprising at least one string of SGEs to pass resources from a first group of neighboring permeable layers, to a second group of neighboring permeable layers. The first and or the second groups may comprise resource delivery sources. The total number of vertically disposed layers ranges from 2 to 10, and more preferably from 10 to 100 and even more preferably in excess of 100 layers.

The permeability feature of the present invention enables the sharing of resources, including water, nutrient, illumination, heating and cooling and other sharable resources. The sharing of said resources enables their efficient use, thereby minimizing the ultimate product cost. The 3D yield or 3D productivity is measured in units of weight divided by volume and units of time. Therefore, the permeable means for sharing resources are designed to produce the maximum product weight in the most compact 3D space in the shortest time. These means are described with aid of FIGS. 4A-4D.

Referring to FIG. 4A an exemplary multi-layer system 300, comprising at least layers 301, 302, which are built by stringing a plurality of SGEs 1, as described in more details above and in FIGS. 2G-2K. Layers 301, 302, and the connecting structures, 301a-301c, and, 302a-302c as well as SGE structures, are made substantially optically transparent so as to allow light rays 305a-305d from sources (not shown) to pass through layers 301, 302 to illuminate the plant shoots 303s, 304s of neighboring layers. The optical transparency of layer structure is made possible by means of transparent materials chosen from at least glass, polycarbonate, polyethylene, and polypropylene, polystyrene.

This means of achieving of light permeability enables multi-layers to share at least one light source for growing plants, thereby realizing the maximum efficiency of the light source. As it may be appreciated, seedlings are small and are separated by wide lateral and vertical spaces. It takes months before the space between them is filled. During this time the light that is not absorbed by one layer, passes through to be absorbed by neighboring layers. The end result is a few light sources are used to illuminate a large number of layers. This immediately results in the reduction of initial capital cost of the light sources. For example, a 100 layer (permeable) system may be served by only one planar light source located on top of the system. By adding reflecting system walls, minimum light is wasted.

By contrast, prior art 3D farming system in FIG. 1C contemplates using one set of light sources for each layer, clearly revealing how wasteful prior art teaching is. It further validates the significance of the permeable inventive feature of the present invention.

In addition to minimizing the initial fixed cost of light sources, the permeable layers also use the consumable light energy efficiently, lowering the variable cost of production. Any light that is not absorbed by a permeable layer passes through to adjacent layers to be consumed by plants in these layers. In prior art teachings, the light energy that is not absorbed by plants is irretrievably lost as a wasted resource.

Referring to FIGS. 4B-4C, another type inventive permeability feature is described. It pertains to the roots 303r, 304r, and shoots 303s, 304s (stems, branches, leaves) of plants in one layer penetrating (sharing) the space of roots and shoots of plants in adjacent layers 306, 307. This space sharing achieves an unprecedented vertical compression, reducing the vertical height d, 308, 308a, many times. The absence of this space sharing would have required maximum height for roots which added to the maximum height of shoots, and the system would vertically less compact.

FIG. 4D illustrates yet another type of permeability, which is the ability of one layer to pass through unabsorbed nutrients to adjacent layers. Nutrients essential for sustaining optimum growth of plants are provided by sources (not shown) in the space 309 occupied by at least the multi-layers 301, 302. Exemplary sources include fogging system, spraying system, and dripping systems which intermittently fill the space 309 with nutrients. These nutrients are delivered to the plants by means of foliar feeding or root feeding. FIGS. 2G-2K, show that string of SGEs in each layer are spatially separated by empty spaces which allow the nutrients to pass from one layer to the next. This permeability also minimizes the number of feeding sources and their initial cost.

Traveling Seed Amplifier and Continuous Flow Farming

In the above, and in my CPPA-1, I used AgriPAL and PGM as the guiding principles enabling the realization of the full potential of 3D SansSoil farming paradigm. Emphasis has been placed on the ability to control physiological and physical parameters. It achieved higher gain and therefore higher efficiency, increased space utilization efficiencies, by means of vertical compression, layer permeability and by making ultra-compact layers comprising strings of networks of integrally made SGEs.

We now introduce the concept of layer mobility, to endow the system described in FIG. 2A with new capabilities including the temporal compression of the plant growth cycle, and an additional means to achieve more vertical space compression by means of automated, on the fly, adjustment of the mobile interlayer spacing according the age of the growing plant. This inventive feature of mobile layers enables the continuous flow farming by the synchronous planting and harvesting of material products, MP, including plant-made-products, PMP, for a wide spectrum of uses, including:
all kinds of foods: staple cereals, legumes, vegetable, nutraceuticals
bio-energy: peanuts (diesel)), sugar beat (ethanol), Russian dandelion (butanol), Algae-biofuel
Medicines: Lettuce, tobacco, algae (vaccines, therapeutic proteins, mAb).
Industrial Materials: natural rubber, PE, PP, enzymes, gels
DNA, RNA, lipid, proteins, polysaccharides

Making the layers, 103 mobile, enables the realization of the concept of traveling seed amplifier, TSA, to continuous flow agriculture. TSA is analogous to a signal amplifier system in the electronics and communication fields, wherein a weak signal is connected to input port, immediately, synchronously, emerges from the output port as an amplified signal (replica of the input signal) with a large gain, (10-1000). The TSA system, 400, in FIG. 5A, is a 3D SansSoil continuous flow farming system for the production of material products.

Analogous to a typical electronic signal amplifier, it amplifiers an initial material mass, mᵢ, applied, inserted, to an input port, at an initial time, τᵢ, then amplified to a final M_{f}, extracted, harvested, at an output port, harvesting port, at a time τₕ. This final amplified mass having gain,

$${G}_{sth} = ( {M}_{f} ( {τ}_{f} ) - {m}_{i} ( {τ}_{i} ) ) / {m}_{i} ( {τ}_{i} ) = \frac{M ( ∞ )}{{m}_{i} ( {τ}_{i} )} {e}^{- {k}_{t} {τ}_{i}} ( 1 - {e}^{- {k}_{t} {τ}_{sth}} ) ,$$

is a replica of the initial mass mᵢ. Even though, each initial mass requires a species dependent time, τₛₜₕ=τ_{f}−τᵢ to achieve the gain, Gₛₜₕ, the rhythmic, periodic or near synchronous planting of m, and harvesting of its replica M_{f}, takes place at a harvesting period τₕ much shorter than τₛₜₕ. Therefore, this inventive TSA system realizes an apparent growth cycle temporal compression of, τₛₜₕ/τₕ=N, where N is the number of growth layers. Conventional farming, with N=1 does not the benefit from temporal and special compression that result in temporal and spatial resource utilization efficiencies according to the instant invention. The TSA system may be designed to achieve gains, Gₛₜₕ having values in the ranges of 2-10, preferably 10-1000, more preferably 1000-100,000, for cell cultures, and event more preferably 100,000 to 100 million. To achieve a desired gain, the TSA system design may start with initial mass mᵢ(τᵢ), at any temporal position, τᵢ, on the growth trajectory, including τᵢ=0, or kᵢτᵢ=γkᵢτₛₜₕ,where γ may be in the range of 0-0.1, or 0.1-0.2; or even 0.2-0.5

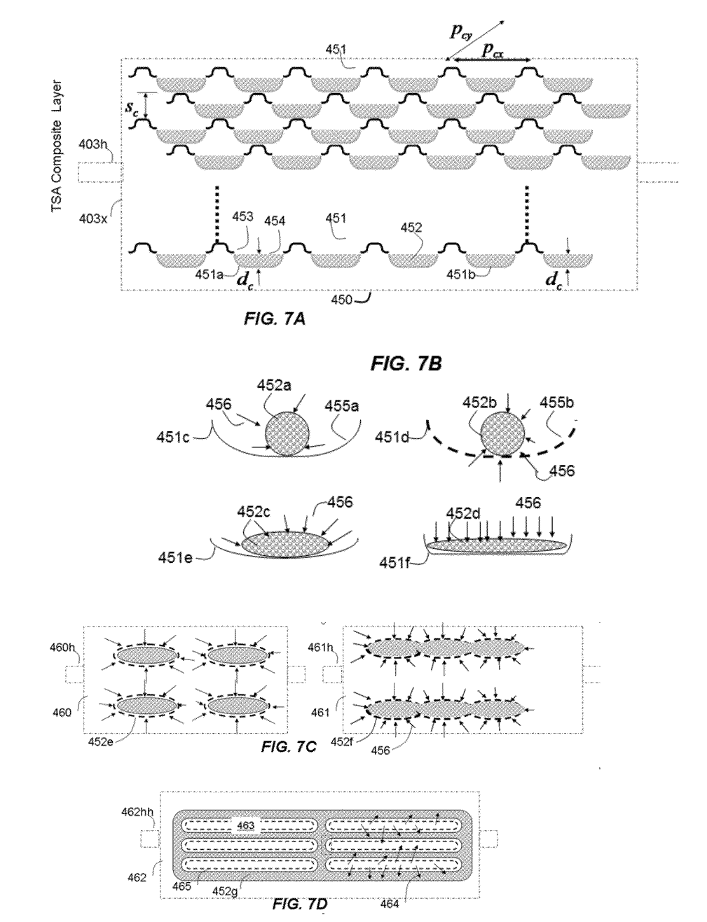

The initial mass, mᵢ, also referred to as seed mass, may be one or more masses selected from the group that includes: {seeds, seedlings, plant cell culture, micro-organism culture, microalgae culture, bacteria culture, fungi culture, stem cuttings, root cuttings, leaf cuttings, eye cuttings}. Said initial mass is planted in one or more SGEs, in one or more growth trays, wherein said SGEs are arranged one dimensional, two dimensional, and some cases 3 dimensional patterns, as in the cell culture trays 450 in FIG. 7A. These patterns may be regular periodic arrays, or other patterns advantageous for seed growth.

The present invention preferred embodiments, contemplate temporal compression factors, the values of N, ranging from 10 to 1000 preferably from 100 to 10,000 and even more preferably exceeding 10,000, in the case of algae and other culture made products, CMP. The high temporal compression factors have significant implications for growing food and energy. For example, if corn cycle time τₛₜₕ is 100 days, from seed to maturity, the 3D TSA system according to this invention, enables the planting and near synchronous harvesting of corn once per day or 10 times a day for compression range from 100 to 1000. In addition, since the layers N are disposed vertically, the third dimension, the volumetric productivity, and the 3D yield increase by N. This is saves arable land and enables food and biofuel to be planted and harvested daily, continuously or semi-continuously, without the concern that biofuel competing with food for 2D land and other resources.

The TSA system for continuous growth of material products, MP, in FIG. 5A, comprises one or more towers, 401, 402, preferably in pairs. It may optionally comprise a single tower or a cluster of plurality of towers. It also comprises, housings 401a, 402a, an input, planning port, 404 an output harvesting port 405, a utility subsystem, 406, for resource delivery and system control (subsystem 102 in FIG. 2A), and a plurality of mobile layers 403a, 403b, traveling upward in tower 401 and downward in Tower 402. The construction of the MP growth layers in towers 401, 402 incorporate the inventive features described above. More specifically, the 3D array compactness, and space compression means, of interconnecting a plurality of SGEs into strings disposed in horizontal planes or vertical planes. The overall system performance also benefits from the multifunction capabilities, discussed above, of each individual SGE. The SGE may generally be used to amplify materials not only based on high plants, but also other materials including algae culture, and other cell cultures. The SGE for these other material sometimes are referred to as reactor growth elements or bio-reactor growth elements.

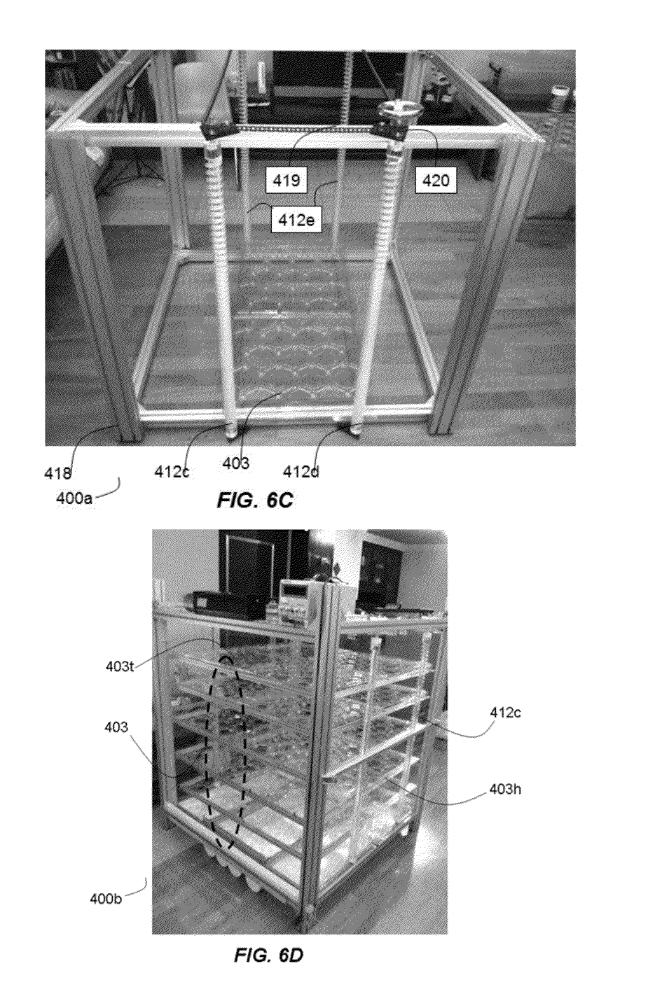

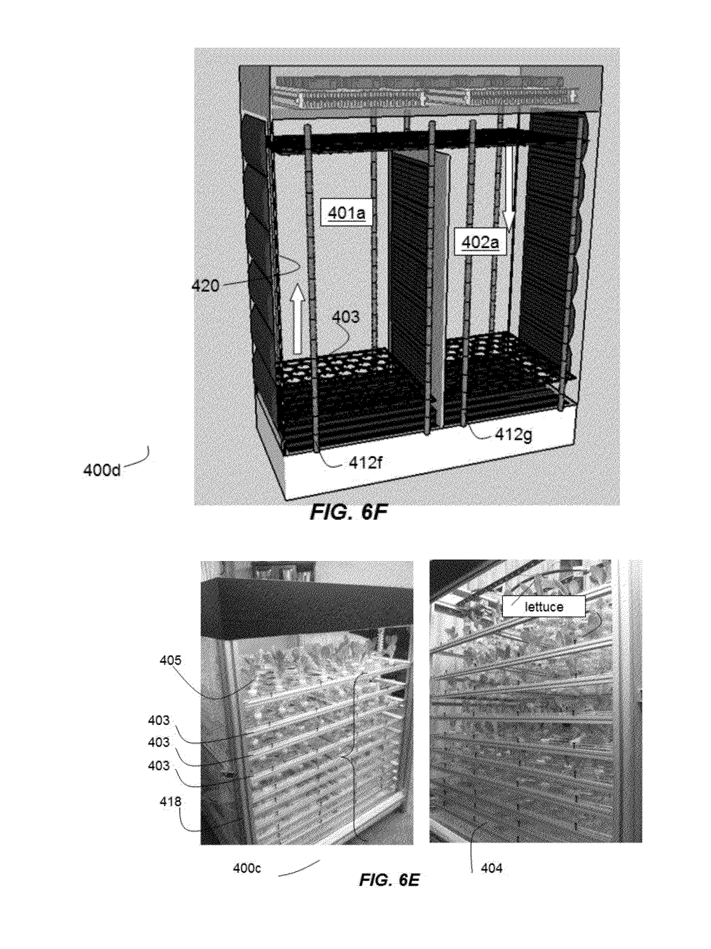

In normal operation, at least one layer 403c comprising at least one initial mass material, at a first age, τᵢ, is admitted by transport means described below, FIG. 6A, into at least one initial location input location or planting port 404 in a position 404a. The initial mass material may be plant seed, seedling, or cell cultures which will be amplified. The layer 403c is moved one layer position upward and concurrently all other layers in both towers shift to the next adjacent position, until the last position 405a in the second tower is refilled. This last position 405a, had just been vacated a short period earlier, δτᵢ by the harvesting operation of layer 403d at its second age τ_{f} at the harvesting port 405. h The synchronicity period δτᵢ is measured from: i)—the time of harvesting layer 403d; ii)—vacating the last position 405a; iii)—shifting all the layers to their adjacent positions; iv)—refilling position 405a; v)—vacating the first position 404a; and finally iv)—inserting layer 403c, in position 403a. The degree of synchronicity is defined thus: d_{sync}≡δτᵢ/τₕ. In normal operation, perfectly synchronous planting and harvesting is achieved in a design that achieves d_{sync}≈0. In other near synchronous designs in normal operation, d_{sync} may have values ranging from 0.001 to 0.1, or may approach 0.5. In these normal operations, the synchronicity is controlled by the system controller, or by manual operation. However, in other non-normal operations, d_{sync} may exceed 0.5.

The preferred embodiment for layer transport mechanism, further comprises a means for lateral transport of layer 403e, from position 4004b in the first tower 401, to a second position 405b in the second tower 402. A non liming example to implement the lateral transport means, is an electromagnet that latches to layer 403e, so that together they move laterally in a synchronized manner with the layer transport systems described in in FIG. 6A, 6B. Once layer 403e is in a predetermined position in tower 402, the electromagnet will unlatch, to enable layer 403e in a condition move downward.

The steps of admitting layer, 403c, shifting all layers, and harvesting layer 403d, are continuously, semi continuously, or intermittently, repeated with a regular compressed time period τₕ, which determined by the following expression:

$${τ}_{h} = \frac{{τ}_{sth}}{N} \approx \frac{{h}_{av} {τ}_{sth}}{2 {H}_{s}} = \frac{( {C}_{TSA} {h}_{h} ) {τ}_{sth}}{2 {H}_{s}} ,$$

where, τₛₜₕ=τ_{f}−τᵢ, the seed to harvest time, also the cycle time, is the difference between a first age, initial tine, τᵢ and a second age, harvesting time, τ_{f}. The cycle time ranges from 1-10 days in the case of algae, and other living cells, 20 to 40 days for lettuce, or from 80 to 120 for soybean, wheat and other annual plant, or 100 to 1000 days, in fruit trees.
Hₛ, is the tower height 408, which ranges from 1-10 m, or 10-100 m or even larger that 100 m; N, is the total number of layers 403, ranging from 10-100, or 100-1000; hₕ, is the plant height at harvest time, before flowering for vegetable products, or after fruit, seed ripening.

$${C}_{TSA} ≡ \frac{{h}_{av}}{{h}_{h}} ,$$

is the vertical space compression which reduces the average interlayer spacing, hₐᵥ. Compression factors between 2 and 5 are possible even 5 to 10 in systems where plant strings are mobile in two spatial coordinates and the plant spacings in two directions are automatically adjustable according to plant age. The interlayer h₃, 408a, varies from the smallest height of the seed/seedling layer at position 404a, to the maximum height, hₕ, at position 405a. This results in the compressed average height hₐᵥ.

The ability to adjust the interlayer spacing 408a, in real time, while the layers are transported, to maintain the correct interlayer spacing according to the plant age, is accomplished by the unique transport mechanism depicted in FIGS. 6A-6B described below. This uniqueness enables tens of layers to move, adjust and maintain the correct interlayer pacing, yet they are able to receive nutrients by inventive delivery subsystems according to the present invention, in a many impossible to achieve using prior art teachings of hydroponic and aeroponic methods.

The compression factor also incorporates the other space saving features discussed above, including: the permeability, the shoot and rood volume overlap, the ultra-compactness of SGE connected in networked of strings in layers 103, 403.

Returning to FIG. 5A, the two tower housings 401a, 402a, instead of being separated with a space 407, they may have a single common housing. They optionally may be sheltered in yet a third housing which also shelters additional tower cluster, downstream processing equipment, and other facilities. In other options, when the TSA towers are housed in a larger enclosed protective environment, the housing structures 401a, 402a, may be open to said larger protective environment, or may be eliminated altogether. Additionally, the tower housings may be substantially transparent, to optionally allow solar illumination, in addition to artificial lighting. They may also comprise variable transmission windows, retractable curtains comprising filters, absorbers, and reflectors.

The subsystem 406 controls all aspects of plant growth delivered by subsystem 102, as discussed above and illustrated in FIG. 2A, in addition it controls additional functions of TSA system 400, including: vertical layer transport, lateral transport (no shown), tower rotation, planting and harvesting, and load lock control. In another aspect of the invention, the TSA tower system 400 may be a member of tower clusters, each comprising a plurality of towers. It is contemplated that the subsystem 406 of each TSA tower communicates with a cluster master controller remotely, the latter, in turn, may communicate with yet another master controller located in a remote location. Persons familiar with the art of remote control can execute these tasks.

In other aspect of the invention, it is contemplated that the towers are rotated at an appropriate speed to track the sun and or to improve the illumination uniformity from the sun or an artificial lighting source.

In other embodiments, to ensure food safety, the towers are equipped with sterility functions, to protect the plants from harmful pathogens and also to consumers from harmful pathogens. It is contemplated that isolation may be achieved by installing load locks in the planting and harvesting ports 404, 405. Each load lock is a chamber comprising sealable doors that enable the sequential transfer of seed layers in (initial mass) in, and harvested products out. The seed layers are admitted through a first door that is in communication with the outside environment. This door is subsequently sealed, and the layers are sterilized in situ. Subsequently, a second door, which is in communication with the main TSA system housing, is opened, and the layer 403c is transferred to its position 404a. The next step is resealing the second door, making it ready for the next repeat cycle. The operation of harvesting load lock chamber is the same except the steps are in reverse. Aspects of the invention contemplate automated transfer of layers and trays from chambers 404, 405, or optionally semiautomatic or manual transfer. In other embodiments, human operators may be involved in the process of planting and harvesting inside the sterilization load lock chambers. In this case, sterilization methods for humans will be adopted as is well known in the sterilization art.

The above operation is referred to as continuous flow farming. As in the case of electronic signal amplifier analogy, the inventive TSA, daily, continuously, admits, plants seeds/seedlings and harvests synchronously products for immediate consumption by consumers or for downstream processing converting them into other forms of the products. By the term continuous we mean a synchronous planting and harvesting operation at a periodic rate, N/τₛₜₕ=1/τₕ. This is contrasted with conventional agriculture, wherein cereal seeds are planted in the fall and harvested late summer or after τₛₜₕ of about 8 to 9 months have elapsed. In the present invention planting and synchronously harvesting [intermittently] once every day or every 5 hours is referred to as continuous or semi-continuous because of the regularity [regular period] of the operations. Furthermore, in continuous flow farming, the daily harvesting, in some cases several times a day, for very tall towers, takes place uninterruptedly, 24 hours a day all year around. Even though, there is a non zero time period between the synchronous planting and harvesting, the operation is 24/7 uninterrupted operation and on a time average basis, we use the term continuous relative to conventional farming wherein the period between planting and harvesting may be a year or longer.

This unprecedented productivity is made possible by the 3D SansSoil controlled environment architecture, and TSA. Depending on the number of layers, the plant species, and the height of the towers, enormous arable land savings is realizable by having 3D hectares in the sky. For examples, sugar beet 2D yield is about 16 ton/hectare/year of sugar, assuming harvest index of 16% (sugar output). Using 100 meter TSA tower, continuous flow farming can produce 173 tons/hectare, of sugar each day continuously or 63,145, t/ha/year. This is because the plant height is only 50 cm, making it naturally suitable for 3D architecture. This example illustrates an astonishing land saving of about 4000 fold. Consequently, this TSA continuous flow farming has the potential to solve the arable land limitation problem, that has posed a dilemma of feeding the world and the resource competition associated with the issue of “food vs. biofuel.

TSA Vertical Compression Embodiment

My CPPA have discussed temporal, spatial and physiological loss mechanisms, contributing to the low plant efficiencies, ˜0.001%, Table 1, and taught inventive means and methods to recover between 10-100 times of those losses. The present TSA embodiment contributes two compression mechanisms:

1. Temporal compression of plant cycle time which is shown examining the planting and synchronous harvesting time expression given by:

$${τ}_{h} = \frac{{τ}_{sth}}{N} \approx \frac{{h}_{av} {τ}_{sth}}{2 {H}_{s}} = \frac{( {C}_{TSA} {h}_{h} ) {τ}_{sth}}{2 {H}_{s}} ,$$

which reveals that the intrinsic physiological plant cycle time is effectively compressed by a factor,

$$N = \frac{( {C}_{TSA} {h}_{h} )}{2 {H}_{s}} .$$

We refer to this as the agronomic temporal compression, “pseudo-compression”, which is designed in the TSA tower system. The inventive variable pitch screw layer (tray) transport mechanism described in FIGS. 6A-6B, is the key contributor to the temporal compression paradigm.
Typical annual crops, soy bean, and cereals have intrinsic τₛₜₕ in the range of 100-120 days, and hₕ˜1 m, will achieve a planting/harvesting TSA time,

$${τ}_{h} = \frac{( 0.33 \times 1 m ) 120 days}{2 \times 100 m} = 0.2 days ,$$

for 100 m tower and C_{TSA}˜0.333. This is a non limiting example to illustrate the power of TSA 3D sansSoil farming architecture. The antisense times varying according to species and growth conditions
Another example related to algae culture for biofuel production, τₛₜₕ˜10 days, and hₕ˜0.01 m, will achieve a planting/harvesting time

$${τ}_{h} = \frac{( 1 \times 0.01 m ) 10 days}{2 \times 100 m} = 0.0005 day or 22 sec .$$

2. Vertical space compression factor, C_{TSA}=hₐᵥ/hₕ, is another vertical space saving method achieved by means of the variable pitch screw mechanism. Recognizing that the plant height in the first of 10-20 days is much smaller than the full height hₕ at maturity, affords the opportunity to reduce the overall tower height for the desired optimum number of layers, by a factor C_{TSA}=hₐᵥ/hₕ, where hₐᵥ is an average interlayer spacing determined by the physiology of the plant, its temporal growth trajectory, and engineering design considerations which are presented in the next section.

FIG. 5B is an exemplary plant height growth trajectory curve and plant biomass growth trajectory described, respectively, by the following expressions: h(t)≈h(∞)(1−e^{-k}^{ₜ}^{t}); M_{BM}(t)≈M(∞)(1−e^{-k}^{ₜ}^{t}). These functions are not intended to limit the present invention; they are used to illustrate the concepts. These functions also approximately describe the growth trajectory of other living cell cultures, microorganism, and the like. These functions may composites which comprise two or more growth phases of different growth rates. For example, a composite function may have an exponentially rising component, f₁(t)=mᵢe^{k}^{₁}^{t} with a first growth rate, k₁, and a second components f₂(t)=M(∞)(1−e^{-k}^{₂}^{t}), wherein at a certain growth phase at a certain time, these components and their first derivatives must match.

There are at least two possible product scenarios:

i)—Harvesting the product in the vegetative state, point A, where the harvesting height hₕ is smaller than the maximum height h(∞) at a harvesting time τₛₜₕ(A).
ii)—Harvesting the product after full maturity and ripening the fruit and the seed, at point B, where the harvesting height hₕ is the maximum height h(∞) at a harvesting time, τₛₜₕ(B) These growth trajectories are experimentally determined for each plant and its growth environment.

We use soybean growth trajectory to show the role of the physiology plays in TSA temporal and spatial compressions with the air of FIGS. 5C-5D. In a TSA system, the selected mobile layers at plant heights h₀, h₅, h₂₀, h₄₀, h₆₀, and h₁₂₀, (other layers are not shown for simplicity) correspond different times on the growth trajectory of soy bean. These layers also show the soy bean morphologies at different ages, from seedling emergence, at hₒ to the last layer h₁₂₀, after 120 days, which is ready for harvest. In order to illustrate the concept of vertical space compression leading to an average height hₐᵥ and a compression factor C_{TSA}=hₐᵥ/hₕ, the cycle time for soybean, is divided into 120 time intervals, Δt=1 day. In this non-limiting illustrative example, soybean seeds would be planted daily at, and mature dry soybean pods are harvested synchronously (daily) at h₁₂₀. One seed layer goes up one position in the left TSA tower and mature harvested layer goes down in the right TSA tower. This is a daily amplification of the seed biomass. In other examples when N is 1000 layers and beyond, then Δt will be less than 0.1 day. In the case of species with intrinsic τₛₜₕ of hours or days, Δt will be measured in minutes or even seconds.

In FIG. 5D, a segment 410a of the whole soybean growth trajectory 410 is shown on the left. The segment 410a is magnified to show more details of the time period corresponding to heights from h₀ to h₂₀, wherein said time period is divided into 20 intervals Δt. Also shown are layers 403 vertically located in their respective heights from h₀ to h₂₀. By examining the height of each layer and its one-to-one correspondence to the height on the growth trajectories, 410, 410a, it is revealed that the layers are traveling at a constant speed along the plant growth trajectories 410, 410a. This means that the interlayer distance is automatically adjusted to keep up with the growth of plant height. It is also revealed that the interlayer distances, early in the growth stage, of layers h₀ to h₁₀ are much smaller than the interlayer distances of the later stage, layers h₁₀ to h₂₀. This proves that the interlayer distance averaged over the whole 120 layers is compressed by a factor C_{TSA}=hₐᵥ/hₕ<1. It can be shown, that depending of the species growth trajectory and whether the harvest time of the product is τₛₜₕ(A), or τₛₜₕ(B) compression factors between 1.5 and 4 are achievable. Using suspended SGE strings that allow variable inter-SGE spacing, px and py, in addition to the vertical, pz, just described, compression factors approaching 10 are possible.

The determination of the compression factor is subjected to engineering design considerations related to the structure and cost of the plant growth layers. FIG. 5E is an illustration of linearization of the growth trajectory that aid in determining the number of layers and interlayer spacing for each of the 5 linearized segments 410a to 410e.

As shown in FIG. 5F, in other aspects of the present invention, flexibility is allowed with regard to the locations of the planting and harvesting ports, 404a, 405a in TSA system 400d, or 404b, 405b, 405c in system 400e. The system may have more than one planting port or more than one harvesting port in locations determined by overall function of the system.

Yet in another aspect of the invention, the system, 400f, has growth layers 403 which may be disposed in the y-z spatial coordinates, i.e., vertical planes as shown in FIG. 5G. In this case the TSA transport system moves the layers horizontally with a constant velocity so as to adjust in real time the interlayer spacing 420a at the seedling stage to spacing 420b near maturity. This produces a TSA compression in the y direction. In this case the hanging layers may also comprise a plurality of individual independently hanging strings, of SGEs, as shown in FIGS. 3L, 3N, 3P. The spacings between these SGEs vary in the x direction from seedling to maturing spacing, thereby allowing yet a third TSA compression factor. The overall TSA compression factors in at least two spatial coordinate directions can approach 10.

TSA Transport Mechanism

The above temporal plant cycle and spatial compression factors are made possible by means of the TSA transport system, a key aspect of the present invention which is described with the aid of FIGS. 6A-6B. In the broadest sense, it is a system 411, that transports a plurality of layers, 403, at a specific velocity, in at least one direction, and, automatically adjusts and maintains different interlayer spacings, determined by an algorithm that is executed by the system controller.

This algorithm is determined by factors that include the physiological trajectory, growth environment, engineering and cost considerations. In a specific preferred embodiment, the TSA transport system comprises one or more screw rods (or auger-like helical rods) 412a, 412b, having a helical thread comprising one or more pitches, p₁, p₂, p₃, p₄, p₅, p₆, . . . . For TSA towers enabled to have large temporal and spatial compression factors, the screw rods are designed to have variable pitches, a plurality of pitches, the number of which is selected from the ranges 1-10; 10-20, 20-100. These will result in temporal compression factors: between 1 and 10, preferably 10 to 100, and even more preferably, 100-1000, and spatial compression factors, ranging from 1 to 10. Compression factors of larger than 10 as also achievable, according to the present invention, by means of the cumulative effects of space saving from root-shoot overlap, from the compactness of the integral construction of SGEs, as discussed above, and the TSA automated variable interlayer spacing adjuster 411 in FIGS. 6A-6B.

The growth layers 403 generally comprise one or more trays (plurality of trays) 403t each comprises one or more SGEs, and a frame or a handle structure 403h that supports the trays. One or more trays are removably attached to their respective handle structures. Even more preferably, in some embodiments, the trays are deposable, one time use. Said one or more SGEs, are in the form of at least one network of strings, and more preferably in the form of one dimensional or two dimensional arrays. Each tray is in communication with fluid delivery and light delivery subsystems (not shown). The handle structure 403h is in direct physical communication with the screw rods 412a, 412b at contact regions 416c, and 417c. When the rods experience synchronous rotation in the directions 416, 417, the contact regions 416c, 4417c of the handle structure are pushed upward or downward, moving with them all layers 403. The interlayer spacings are maintained by the rod pitch associated with each tray vertical location and maintain spacings. The tray and handle thicknesses may not have the same values. These thicknesses are chosen from these ranges: 10-100 micron, 100-1000 microns, 1-10 mm, and 10-100 mm. While the periodic or non periodic spacings between SGEs are chosen from these ranges: 10-100 micron; 100-1000 microns, 1-10 mm, 10-100 mm, and 100-1000 mm

The thread-form of the screw rods are machined in such a way that the depth and the flank shapes of the thread can accommodate and hold the handle structures 403h of the growth layers and have the strength to accommodate the layer's load. The spacing between the screw rods enables the growth layers to be held firmly yet with the ability to be easily removable, during the steps of planting and harvesting. For synchronous rotation, the screw rods 412a and 412b are coupled to a subsystem comprising at least one motor, at leas of one set of chain belt-gear arrangement and supporting structures fixed to the mainframe housing. The rods counter-rotate, 416, 417, cooperating synchronously to lift all the layers 403 upward or downward at the contact regions 416c, 417c. While the angular velocity is kept contestant, the layers move at different linear speeds depending on the local pitch. This results in interlayer spacings 413, 414, 415 having different values at different heights determined by the pitch values. The pitch variation as a function of height is determined by an algorithm which at least reflects the plant growth trajectory that is measured experimentally.

The number of screw rods needed to transport the growth layers varies from 1 to 10. For example in system 400f, the hanging growth layers 403 are transported to the right by means of a single screw rod 412c, that is it rotates, it translates the layers linearly, while at the same time adjusts and maintains the correct interlayer spacings 420a, 420b, according to the age of the plants. This single screw rod arrangement, in addition to its simplicity, and low cost, it has a major additional advantage in that it does not need to support the weight of the hanging layers. It only needs to push to translate the layers after overcoming frictional forces.

In other embodiments, when the plant growing layers are horizontally disposed and move up and down (z direction), at least three screw rods are required to balance weight support against gravity forces. In other instances, 4, 6 or even 8 rods may be required.

In another aspect of the invention, the variable pitch thread-form may be incorporated in the inner surface of a rotating cylindrical housing to enable the upward or downward motion of N layers. Said N growth layers have areas or diameters designed to efficiently occupy the volume of the rotating cylindrical housing. The incorporation of the thread-form may be accomplished by means of machining (or embossing) substantially the entire inner surface. To lower the cost, especially when the diameter exceeds 1 meter, it may also be accomplished by the partial machining (or embossing) of the inner surface. The partial machined (embossed) area covered, may be in the form of a plurality of axially oriented thread-form strips. The number of these strips may be in the range of 2 to 6 or 6-24 if the diameter is very large. The length of the strip is approximately the length of the cylinder, and its width is a fraction of λ×diameter. This fraction may be between ⅛ and 1/32, or may be smaller than 1/32, depending on the number of strips and the design of the layer structure.

Yet another option is to avoid machining or embossing the inner surface, and instead, a plurality of thread-from strips is fastened to the inner surface of the cylindrical housing.

Although the variable pitch screw rod system is the most advantageous solution to the problem, of self-adjusting interlayer spacing as a function of growth, there are other mechanisms persons skilled in the art may conceive based on moving belts and chains. Applicant has discovered that the variable pitch rod mechanism features many more advantages including: high performance, compactness, low noise, low cost, flexibility, and scalability to very high tower heights.

The TSA Proof-of-Concept, POC

The POC, according to the present invention, has been designed and built and evaluated for growing lettuce as a vehicle to validate its operability, and the key inventive functions that make the TSA unique. FIGS. 6C-6E depicts the reduction to practice of the POC demonstration. The system 400a has a base of 1 m2 and a height of 1 meter, designed to accommodate 20 growth layers. Lettuce was chosen as an example that represents food products, and when genetically transformed, it represents medicinal products, vaccines, and antibiotics.

In FIG. 6C, the main frame extruded aluminum housing structure, 418, is shown, to which four screw rods, 412c, 412d, 412e, are attached. Also shown are sprocket gears, a chain belt and a manually rotated wheel. The motor driving this transport mechanism is on top in FIG. 6D. Aluminum frames or handles 403h are shown supporting transparent growing trays 403t. The frame, 403h along with 4 trays 403t constitute a complete layer 403.

FIG. 6E shows two perspectives of a substantially complete POC system, 400c, comprising: the housing 418, the planting port 404, the harvesting port 405, plurality of growth layers 403 populated with lettuce at ages corresponding their height, permeable to light, nutrient, and roots and shoots of neighboring layers. As can be seen, the interlayer spacing varies from very small at the bottom, 2.5 cm, to 25 cm at the harvesting port, reflecting the ages of lettuce. The system also comprises the master controller for controlling the motion of the layers, the Pulsed LED lighting, water, nutrient delivery, pH, temperature, and relative humidity, described in my CPPA

FIG. 6F, illustrates system 400d which is a scaled-up design version of POC system 400c, in FIG. 6E, with 4 screw rods 412f for upward motion and 4 screw rods 412g for downward motion. This is a modular design which can be built into a pair of towers of different scales with heights ranging from few meters to more than 100 meters, each has a chamber 401a for layers 403 that move upward, and chamber 402a for layers that move downward. The side walls are shown to comprise the LED illumination option. The housing may be transparent so that solar illumination is provided as an option.

The transparent trays 403 are uniquely designed in a hexagonal SGE array configuration capable of many functions, including, germination, amplification, mobility, interlayer spacing adjustment, and water and nutrient delivery with virtually no plumbing. The POC transparent hexagonal arrays are visible in the trays of FIGS. 6C-6D. The hexagonal array of a specific layer is rotated relative to its neighboring layers, in the manner to allow said specific layer to receive water and nutrient of a layer on top, delivers water and nutrients to its own plants, and relay the rest to the bottom neighboring layers. This relaying function enables the entire layer to receive an appropriate nutrient level needed to sustain growth.

Levitated Bio-Reactor for Culture Made Products

In another preferred embodiment, the TSA systems along with the TSA transport mechanisms described above, FIGS. 6A-6B and POC systems FIGS. 6C-6F for growing lettuce, may also be used, instead, for cell culture (suspended of immobilized) for the production of MP, including plant made products, PMP, and culture-made-products, CMP. They may also be used for the production of other materials that rely on catalytic or enzymatic conversion reactions of one or more substrates. The latter reaction processes are analogues to cell culture methods, except that the catalysts are made of non-living matter, including molecular sieve, zeolite families, metals, and other particles comprising acid or basic catalytic sites. All of these methods for the production of matter benefit from the inventive features of TSA and TSA transport mechanism.

The culture methods may include prokaryote, eukaryote cells, microorganisms, algae, cyano-bacteria, other bacteria and fungi, and a variety living organisms generally referred to as autotroph, photoautotroph, heterotroph, or mixotroph. These cells represent naturally evolved species or genetically transformed by well known recombinant DNA engineering methods. These methods may include transient (plastids) or nuclear genetic transformation. In these cases, the trays are specifically designed to comprise one dimensional or two dimensional SGE arrays 400 in the form of micro-wells or troughs, 451a, 451b, 451c, 451d, 451e and 451f, as shown in FIGS. 7A-7B. Each composite TSA mobile layer 403x, comprising a handle structure, 403h, and one or more trays 451. In a TSA system, a plurality of TSA composite mobile layers 403x, are transported according to the present invention by means of the TSA transport mechanism 411, FIGS. 6A-6B.

Each of the plurality of trays 451, in the composite layer, is designed to have a specific structural strength that enables the stacking of a large number of trays, so that they can move as one unit, a composite layer, and to support the total load including that of the culture mass 452. The trays 541 are designed to comprise self-alignment features relative to the neighboring layers and to maintain inter-tray spacing s_{c}.

The trays 451 are so designed as to facilitate the filling, or emptying of the culture and culture media, in a single operation, of all the micro-wells 451a in a composite layer 403x. The single filling operating enables the automatic adjustment of the micro-well levels 454 to achieve an identical full height d_{c}. This single operation filling is accomplished by means of perforations 453 in all the trays. The culture growth element arrays of the trays have periods in two dimensions p_{cx}, and p_{cx}, which may be in the ranges of 10 to 100 microns, 100 to 1000 microns, 1000 to 100,000.

The most preferred design feature of the present TSA-based bioreactor is achieving ultra-high surface to volume ratio of the micro-wells, to enable fastest gas exchange as illustrated by the arrows 456 in FIG. 7B which represent the diffusion of metabolite gases in and out, including O2, CO2, alcohols, and other volatile primary or secondary metabolites, depending aerobic, anaerobic or fermentation metabolism of the growing cells. It is desirable to maximize the gas exchange speed for metabolism and growth conditions. This is a accomplished by means of decreasing diffusion lengths of metabolites and increasing the diffusion speeds, such outcomes are facilitated by maximizing the surface to volume ratio which is related to

$$\frac{1}{{d}_{c}} .$$

This is maximized by keeping the depths of the micro-wells as shallow as possible, which is satisfied by keeping d_{c}<p_{cx}, p_{cx} or even more preferably d_{c}<<p_{cx}, p_{cx}. Exemplary non-limiting d_{c} values are chosen from the ranges: 10 micron to 100 microns or 100 micron to 5000 microns. The values are optimized based on well known behavior of dissolutions of metabolites in culture media, temperatures, and pressures.

Making TSA bioreactor exemplified by the composite layer 403x constructions as in FIG. 7A-7B makes a larges volume system production with maximum efficiency, productivity, yield flexibility and scalability at the lowest cost. One of the key to maximizing productivity (volume to volume) is maximizing the culture density. The present invention ensures that, by achieving a large surface to volume ratio with ultra-shallow depth d_{c}, and the immediate access of each cell to the ambient environment for nutrients, and for optimum gas exchanges. Productivities well in excess of 100 mL/L and even more than 500 mL/L are possible. In another aspect of the invention, the culture cells may be immobilized in trays and in mobile layers which can be intergraded in TSA systems that benefit form the high density and productivity features.

Prior art systems bioreactors face scalability problems and their price/performance degrades as higher production is contemplated. The present invention enables a system to be scaled up from few liters to 100,000 liters, retaining the price performance predicted from the operation of a single micro-well or a single tray. The gas exchange remains optimized regardless of the systems size. Typical inter-tray spacings s_{c} may be chosen from the ranges s_{c}=d_{c} to s_{c}=2d_{c}, this will facilitate gas exchanges, as well as the filling and emptying of the culture media

The culture array elements, 451a, 451b, 451c, 451d, 451e and 451f, may be designed to have diverse periodic array geometrical arrangements, configurations and micro-well trough shapes (physical profiles), depending on the benefits that accrues for a specific application growth conditions and growth environment.

One preferred thin walled trough is the concave shape 451c designed from a material and a surface coating 455a that prevents the cell culture and cell culture medium 452a from sticking. This phenomenon is referred to as fouling in prior art bioreactors, especially, algae bioreactors. In these reactors, fouling is considered to be one of major hurdle preventing large scale algae from reaching profitability, as tested by our AgriPAL condition. This non-stick feature according to the present invention enables the filling and emptying of the wells with minimum friction, so that the fluid flows or glides effortlessly and enables the reuse of trays very large number growth cycles ranging from 100 to 1000 or from 1000 to 10,000 and more preferably approaching 100,000 cycles.

Hydrophobic coatings and even more preferably super-hydrophobic coatings, SHC, are contemplated. These coatings are well known in the art. The SHC is characterized by a fluid 452a having very large contact angle in the range of 150° and 180°. This enables the culture medium to form a spherical bead (or cylindrical bead in one dimensional trough) with near zero contact area with the micro-well surface 455a. Such near zero contact area beads, made of culture medium, are inoculated with of growing cell culture.

Since the bead volume is more than a million times larger than a single cell volume, the beads behave as though they are levitated bio-reactors, hereafter; they are referred to by the acronym, LBR. They are levitated, because nearly the entire outer surface of the bead is surrounded by ambient environment exchanging with it metabolite gases with minimum impedance, as the arrow directions 456 show. To further facilitate the gas exchanges 456, with the ambient environment, the LBR 452b in trough 451d, is made to nearly float on the surface 455b that is perforated, mesh-like, porous or otherwise permeable to metabolites. For very small LBR beads having diameters in the range of 100 micron to 1000 micron, large surface to volume ratios are achieved, thereby ensuring optimum gas exchange and highest productivity that exceed 100 mL/L or even exceed 500 mL/L.

LBR comprising diverse shapes and cross sectional areas 452c, 452d, FIG. 7B, may be produced with the supporting micro-well shapes 451e, 451f, comprising shallow depths, and surfaces that are permeable to metabolites. They are designed to maximize gas exchanges to maintain high cell viability and density. The illustrated shapes and cross-sections are meant to non-liming examples. Persons skilled in the art will be able to select other geometries that have advantageous features.

FIG. 7C illustrates an embodiment of layers 460, and 461, comprising a handle structure 460h, 461h, and a plurality of LBR's, 452e and 452f which have their surfaces in contact with the ambient environments for effective exchange of metabolites 456. FIG. 7D illustrates an embodiment of a layer 462 comprising a handle structure 462h, at one culture chamber 452g, and a plurality of gas chambers 463 which are in communication with the culture through permeable surfaces or perforated surfaces covered with super-hydrophobic coatings 465. The latter ensures non-stick surfaces to enable the filling and emptying of the chamber repeated with minimum fouling. The arrows 464 indicate the direction of exchange of metabolites which are designed to have short diffusion lengths and diffusion times, and maximum surface to volume ratio for high density and productivity.

The geometrical configurations, physical profiles and appearances of components, illustrated in FIGS. 6A-6F, FIGS. 7A-7D, are non limiting examples. Skilled practitioners will be able to conceiver variations which will not depart from the inventive features taught by the 3D SansSoil farming paradigm, the TSA tower implementations, the TSA transport mechanisms, and the non-stick culture in the multi-layered arrangements of micro-well levitated bioreactors.

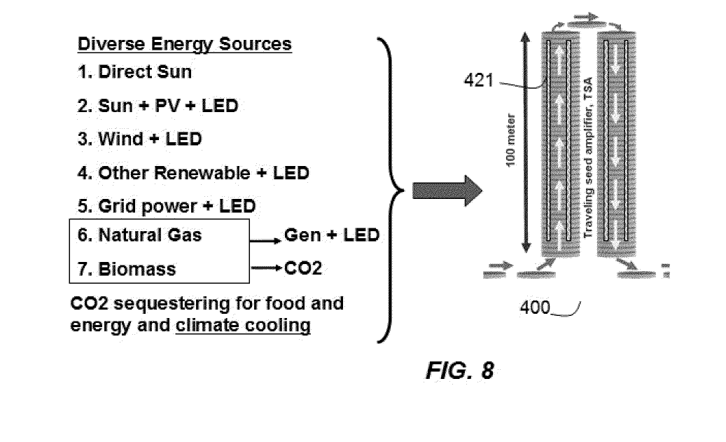

FIG. 8 is an illustration of a TSA tower 400 that describes other aspects of the invention related to energy requirements to sustain plant growth. Specifically, it emphasizes the systems' flexibility in using diverse energy sources and forms, individually or in combination. Unlike conventional 2D agriculture which is constrained to use the only sun illumination, in the TSA system 400, direct sun energy is not a requirement, it is an option. When solar illumination is used with TSA, the system housing is designed to be transparent to the wavelength relevant to photosynthesis.

In the case of artificial illumination, the system generally comprises strings of LED 421, localized near the growing plants in an optimized configuration so as to achieve uniform illumination. These LEDs are driven by means of an electronic subsystem that delivers to the plants light pulses comprising variable frequency, variable pulse widths, shapes, and duty cycles. Applicant has used pulsed illumination to optimize the enzymatic kinetics that experimentally demonstrated improvements in the energy utilization efficiency ranging from 4 to 10, dependent on the plant species. As discussed earlier, and in details in my CPPA-1, artificial illumination, and indoor controlled environment farming, benefit from the ability to increase the photosynthetic efficiency by factors ranging from 10 to 100, AgriPAL, Eq. (2), above, and EVI^{e}≡η_{E}^{e}≡gₑη_{E}.

The LED's primary energy is derived from several electric power options shown in FIG. 8, including:
1. Photovoltaic arrays, PV which harvest and convert solar radiation to electric power, with efficiencies ranging from 10% to 20% or even higher. This electric power is delivered to the pulse generating subsystem that drives the LED 421. This option combines all the advantages of the 3D SansSoil TSA farming with the limitless availability of low cost renewable energy from the sun. The cost advantage is realizable especially when the PV arrays are placed on land that is not suitable for agriculture.
2. Wind turbine electric power generation is another source delivered to power the pulsed LED strings 421. This option enables TSA tower farming for food production in remote areas on lands that are not suitable for conventional agriculture. Most advantageously in geographic locations where the temperature swings are very high and unpredictable. Whether these locations are in near arctic climates or very hot deserts, the TSA controlled environment will be suitable for efficient food and biofuel production.
3. Electricity from other renewable sources combined with LEDs is suitable for power system 400 including hydro power, geothermal, ocean waves and tidal.
4. Grid provided electricity in combination with LEDs is also suitable to power system 400. Grid derives its electricity from coal, natural gas, other fossil fuels, and nuclear fuels.
5. Dedicated multi-fuel generators consuming fossil fuels and bio mass are particularly suitable for TSA system because they combine the following advantages
   a. The ability to sequester CO2 by feeding to the plants for conversion into food of or bio-energy products. This lowers the cost energy, helps the environment and increase profitability.
   b. Overall energy cost reduction by eliminating many costs associated grid based electricity, including location flexibility not tied to transmission line availability.
   c. Recycling of TSA self-generated biomass into electricity using the same multi-fuel generator to drive TSA for illumination, heating, cooling and general TSA function controls.

1. Traveling seed amplifier system for continuous flow farming of material products, MP, comprising:
Plurality of N parallel mobile layers, for growing material specie from an initial seed mass, mᵢ, and initial age, τᵢ, to an amplified mass, M_{f}=Gₛₜₕmᵢ, at a harvest age, τ_{f}, with an intrinsic specie seed to harvest time, τₛₜₕ≡τ_{f}−τᵢ.

2. The system according to claim 1, further comprises a means for compressing said intrinsic seed to harvest time by a compression factor given by
$${α}_{tc} ≡ \frac{{τ}_{h}}{{τ}_{sth}} ≡ \frac{1}{N} .$$

3. The system according to claim 1, further comprises a means continuous planting at least one seed and synchronously harvesting at least one amplified initial mass replica, at a rate determined by; 1/τₕ=N/τₛₜₕ.

4. The system according to claim 1, wherein the means for growing is accomplished by the continuous insertion of at least one initial mass layer, in at least one planting port and synchronous harvesting of at least one amplified mass layer from at least one harvesting port.

5. The system according to claim 2, wherein the means for compressing is accomplished by the continuous insertion of layers at input ports and subsequent transport of said layers for synchronous harvesting at harvesting ports.

6. The system according to claim 1, wherein the number of layers N is determined by, N=2HₛC_{TSA}/hₕ, and wherein C_{TSA} is a spatial compression factor, hₕ is the amplified plant height at harvest, hₐᵥ, the average plant height, hₐᵥ=hₕ/C_{TSA}, and 2Hₛ is the total distance traveled by all the layers.

7. The system according to claim 1, wherein the material species include high plants, algae, microalgae, cyano-bacteria, fungi, or other material amplifying organisms.

8. The system according to claim 1, wherein the material products at least include: polysaccharides, biomass, lipids, sugars, starches, fruits, vegetables, seeds, cereals, alcohols, legumes, RNA, DNA, proteins, precursors for rubbers or other polymers, biofuel.

9. The system according to claim 1, wherein the material products are at least used for food, energy, medicines, industrial materials and specialty materials.

10. The system according to claim 1, wherein the parallel mobile layers move vertically.

11. The system according to claim 1, wherein the parallel mobile layers move horizontally.

12. The system according to claim 1, wherein, the initial seed mass is selected from at least one member of the group consisting of seeds, seedlings, plant cell culture, micro-organism culture, microalgae culture, bacteria culture, fungi culture, stem cuttings, root cuttings, leaf cuttings and eye cuttings.

13. The system according to claim 1, wherein amplified mass is harvested at the vegetative phase of the plant growth trajectory.

14. The system according to claim 1, wherein amplified mass is harvested at the stationary phase of the plant growth trajectory.

15. The system according to claim 1, wherein the parallel mobile layers comprise at least a handle structure and at least one tray comprising a least one string of SGE.

16. The system according to claim 1, wherein the parallel mobile layers comprise at least a handle structure and at least one tray removable attached to said handle structure.

17. The system according to claim 1, wherein the parallel mobile layers comprise at least a handle structure and at least one disposable tray.

18. The system according to claim 1, wherein the parallel mobile layers comprise at least one string interconnected to move vertically.

19. The system according to claim 1, wherein the parallel mobile layers comprise at least one string interconnected to move horizontally.

20. The system according to claim 1, wherein the parallel mobile layers are permeable to resources that include: light, nutrients, gases, fluids, biomass, shoots, and roots.

21. The system according to claim 1, wherein the interlayer spacings of parallel mobile layers are compressed by means of allowed overlap of shoots and roots of at least one neighboring layer.

22. The system according to claim 1, wherein the interlayer spacings of parallel mobile layers are compressed by means of the TSA automated variable interlayer spacing adjuster design algorithm

23. The system according to claim 1, wherein the interlayer spacings of parallel mobile layers are compressed by means space-saving compactness of the integrally made multifunction SGEs.

24. The system according to claim 1, wherein the parallel mobile layers comprise at least one string interconnected to move vertically.

25. The system according to claim 1, wherein the parallel mobile layers comprise at least one string interconnected to move horizontally.

26. The system according to claim 1, wherein the number of layers, N, is designed to be in the ranges: 2-10, 10-100, 100-1000, and 1000-10,000.

27. The system according to claim 1, wherein the parallel mobile layers comprise trays that interconnected to form multi-layer three dimensional array structure disposed in a first, second and third spatial coordinates.

28. The system according to claim 27, wherein the array structure is periodic, in at least one spatial coordinates direction, and wherein the periods are in the ranges: 10-100 micron; 100-1000 microns, 1-10 mm, 10-100 mm, and 100-1000 mm.

29. The system according to claim 27, wherein the layer and tray have thickness values in the ranges: 10-100 micron; 100-1000 microns, 1-10 mm, and 10-100 mm.

30. The system according to claim 1, wherein the number the gain Gₛₜₕ may have values in the ranges of 2-10, preferably 10-1000, more preferably 1000-100,000, for cell cultures, and even more preferably 100,000 to 100 million.

31. The system according to claim 1, wherein the initial mass mᵢ(τᵢ), may start at any temporal position, τᵢ, on the growth trajectory, including τᵢ=0, or kᵢτᵢ=γkᵢτₛₜₕ, where γ may be in the range of 0-0.1, or 0.1-0.2; or even 0.2-0.5.

32. The system according to claim 1, wherein the intrinsic species dependent seed to harvest time, τₛₜₕ, ranges from 1-10 hours, or 10 hours to 10 days, or 10 days to 1000 days, and
initial mass mᵢ(τᵢ), may start at any temporal position, τᵢ, on the growth trajectory, including τᵢ=0, or kᵢτᵢ=γkᵢτₛₜₕ, where γ may be in the range of 0-0.1, or 0.1-0.2; or even 0.2-0.5.
